(19) United States
(12) Patent Application Publication
(10) Pub. No.: US 2022/0229664 A1
(43) Pub. Date: Jul. 21, 2022

(54) INFORMATION PROCESSING DEVICE, COMPILING METHOD, AND NON-TRANSITORY COMPUTER-READABLE RECORDING MEDIUM

(71) Applicant: FUJITSU LIMITED, Kawasaki-shi (JP)

(72) Inventors: Takashi Arakawa, Numazu (JP); MAKOTO KOMAGATA, Kawasaki (JP); Akira HIRATA, Edogawa (JP); Kensuke Watanabe, Numazu (JP)

(73) Assignee: FUJITSU LIMITED, Kawasaki-shi (JP)

(21) Appl. No.: 17/488,359

(22) Filed: Sep. 29, 2021

(30) Foreign Application Priority Data
Jan. 8, 2021 (JP) 2021-002298

(51) Int. Cl. G06F 9/30; G06F 9/38

(52) U.S. Cl. CPC G06F 9/30047; G06F 9/381; G06F 9/30043; G06F 9/30065

(57) ABSTRACT

An information processing device includes a memory, and a processor coupled to the memory and configured to detect an access pattern according to which a memory reference instruction in a first loop process to be executed posterior to a second loop process accesses first data elements in the memory every loop iteration, and insert a prefetch instruction to the second loop process based on the access pattern, the prefetch instruction being an instruction to transfer at least one of the first data elements from the memory to a first sector of a cache memory, the at least one of the first data elements transferred to the first sector of the cache memory being never cached out by a second data element different from each of the first data elements.

### CROSS-REFERENCE TO RELATED APPLICATION

This application is based upon and claims the benefit of priority of the prior Japanese Patent Application No. 2021-002298, filed on Jan. 8, 2021, the entire contents of which am incorporated herein by reference.

### FIELD

The present invention relates an information processing device, a compiling method, and a non-transitory computer-readable recording medium.

### BACKGROUND

Prefetching is one of methods for accelerating the execution speed of programs. Prefetching is a method for reducing the waiting time associated with the data transfer by transferring the data required for the program from the memory to a cache memory in advance.

However, depending on the program, prefetching is not effective enough to accelerate the execution speed of the program in some cases. Note that the technique related to the present disclosure is also disclosed in Japanese Laid-Open Patent Publication Nos. 2010-244205, 2018-010540, and 2001-290657.

### SUMMARY

According to an aspect of the embodiments, there is provided an information processing device including: a memory; and a processor coupled to the memory and configured to: detect an access pattern according to which a memory reference instruction in a first loop process to be executed posterior to a second loop process accesses first data elements in the memory every loop iteration, and insert a prefetch instruction to the second loop process based on the access pattern, the prefetch instruction being an instruction to transfer at least one of the first data elements from the memory to a first sector of a cache memory, the at least one of the first data elements transferred to the first sector of the cache memory being never cached out by a second data element different from each of the first data elements.

### BRIEF DESCRIPTION OF DRAWINGS

FIG. 1 is a schematic view of a computing machine that executes prefetching.

FIG. 2A illustrates a C source code before optimized by a compiler, and FIG. 2B illustrates a C source code obtained after the compiler optimizes the source code illustrated in FIG. 2A.

FIG. 3A illustrates a C source code in accordance with a first example before optimized by the compiler, and FIG. 3B illustrates a C source code obtained after the complier optimizes the source code illustrated in FIG. 3A.

FIG. 4A illustrates a C source code in accordance with a second example before optimized by the compiler, FIG. 4B illustrates a C source code obtained after the complier optimizes the source code illustrated in FIG. 4A, and FIG. 4C illustrates a C source code after the complier optimizes the source code illustrated in FIG. 4A using a method different from the method of FIG. 48.

FIG. 5 is a schematic view for describing the outstanding number when the source code of FIG. 4C is executed.

FIG. 6A illustrates a C source code in accordance with a third example before optimized by the compiler, and FIG. 68 illustrates a C source code obtained after the compiler optimizes the source code illustrated in FIG. 6A.

FIG. 7 is a schematic view illustrating a process executed by an information processing device in accordance with an embodiment.

FIG. 8A is a schematic view of a cache memory without a sector function, and FIG. 8B is a schematic view illustrating cache-out in the cache memory without a sector function.

FIG. 9A is a schematic view of a cache memory having a sector function, and FIG. 9B is a schematic view illustrating cache-out in the cache memory having a sector function.

FIG. 10A illustrates a C source code written in a source program before compiled by the information processing device, and FIG. 10B illustrates a source code obtained by optimizing the source code illustrated in FIG. 10A by the information processing device according to a first prefetch method.

FIG. 11 is a schematic view illustrating an advantage achieved by the first prefetch method.

FIG. 12A illustrates a C source code written in a source program before compiled by the information processing device, and FIG. 12B illustrates a source code obtained by optimizing the source code illustrated in FIG. 12A by the information processing device according to a second prefetch method.

FIG. 13 is a schematic view illustrating an advantage achieved by the second prefetch method.

FIG. 14A illustrates a C source code written in a source program before compiled by the information processing device, and FIG. 14B illustrates a source code obtained by optimizing the source code illustrated in FIG. 14A by the information processing device according to a third prefetch method.

FIG. 15 is a schematic view illustrating an advantage achieved by the third prefetch method.

FIG. 16 is a diagram for describing an access pattern.

FIG. 17A illustrates an example of a source code in a case 1, and FIG. 17B is a schematic view of an entire table.

FIG. 18 schematically illustrates the cache memory at the time of executing each of a preceding loop process and a subsequent loop process when the first to third prefetch methods are executed in the case 1.

FIG. 19A illustrates an example of a source code in a case 2, and FIG. 19B is a schematic view of the entire table.

FIG. 20 schematically illustrates the cache memory at the time of executing each of the preceding loop process and the subsequent loop process when the second prefetch method is executed in the case 2.

FIG. 21A illustrates an example of a source code in a case 3. FIG. 21B schematically illustrates the cache memory at the time of executing each of the preceding loop process and the subsequent loop process when the third prefetch method is executed in the case 3.

FIG. 22 illustrates a source code before degeneration and a source code after degeneration when the first prefetch method is degenerated to the third prefetch method.

FIG. 23 is a source code before degeneration and a source code after degeneration when the second prefetch method is degenerated to an alternative prefetch method.

FIG. 24 is a functional block diagram of the information processing device.

FIG. 25 is a flowchart of a compiling method in accordance with the embodiment.

FIG. 26 is a flowchart of a determination process of a candidate prefetch method.

FIG. 27 is a flowchart of a degeneration determination process.

FIG. 28 is a flowchart of a determination process.

FIG. 29A is a schematic view of the cache memory when “C≥W+Y” is established, and FIG. 29B is a schematic view of the cache memory when “C≥W+Z” is established.

FIG. 30A is a schematic view of the cache memory when “C≥X+Y” is established, and FIG. 30B is a schematic view of the cache memory when “C≥X+Z” is established.

FIG. 31A is a schematic view of the cache memory when “C≥W” is established, and FIG. 31B is a schematic view of the cache memory when “C≥X” is established.

FIG. 32 is a schematic view of the cache memory when “C≥0” is established.

FIG. 33 is a hardware configuration diagram of the information processing device.

### DESCRIPTION OF EMBODIMENTS

Prior to the description of an embodiment, basic matters will be described.

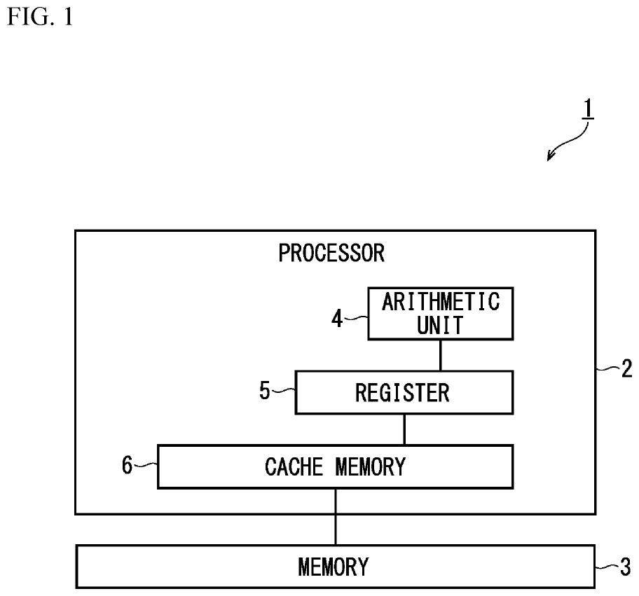

FIG. 1 is a schematic view of a computing machine that executes prefetching.

In this example, a computing machine 1 includes a processor 2 and a memory 3. The memory 3 is a volatile memory such as a dynamic random access memory (DRAM) storing data and instructions.

The processor 2 is hardware such as a central processing unit (CPU) or a graphical processing unit (GPU) including an arithmetic unit 4, a register 5, and a cache memory 6. The arithmetic unit 4 is hardware such as an arithmetic logic unit (ALU). The register 5 is a volatile memory such as a static random access memory (SRAM) that holds data and stores operation results when the arithmetic unit 4 performs operations. The cache memory 6 is a volatile memory such as an SRAM that holds data and instructions stored in the memory 3.

In the above architecture, before the arithmetic unit 4 performs an operation, prefetching is executed to transfer data elements required for the operation from the memory 3 to the cache memory 6. Then, by transferring, to the register 5, the data elements that have been transferred to the cache memory 6, the arithmetic unit 4 can perform the operation using the data elements.

The waiting time from when the arithmetic unit 4 requests data from each memory until the arithmetic unit 4 can use the requested data increases as the memory is farther away from the arithmetic unit 4. For example, the waiting time between the arithmetic unit 4 and the register 5 is shortest, one clock cycle to several clock cycles. By contrast, the waiting time between the arithmetic unit 4 and the memory 3 is hundreds of clock cycles.

Since the waiting time between the arithmetic unit 4 and the cache memory 6 is several tens of clock cycles, the execution speed of the program can be accelerated by prefetching data elements in the memory 3 to the cache memory 6 to reduce the waiting time.

Prefetching may be achieved in software by optimization by a compiler, or may be achieved in hardware. Here, prefetching achieved in software will be described.

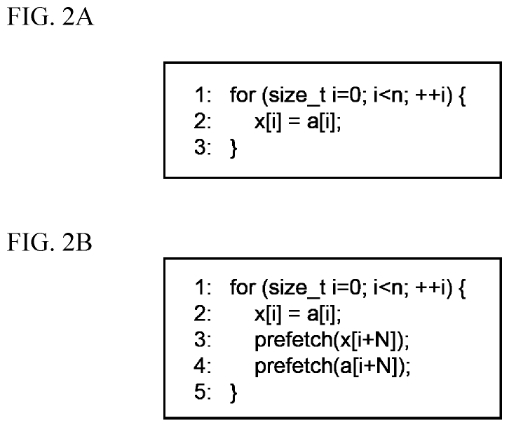

FIG. 2A illustrates a C source code before optimized by a compiler.

In this example, inside a “for” loop, an operation that assigns an element of an array “a” to an element of an array “x” is repeated n times. Hereinafter, n may be also referred to as a loop iteration number.

In addition, a load instruction to store the i-th element of the array “a” from the memory 3 to the register 5 is issued by executing “a[i]” in the second line by the arithmetic unit 4. Mien, a store instruction to store the i-th element of the array “x” from the register 5 to the memory 3 is issued by executing “x[i]” in the second line by the arithmetic unit 4.

FIG. 2B illustrates a C source code obtained after the compiler optimizes the source code illustrated in FIG. 2A.

As illustrated in FIG. 2B, in this example, the compiler inserts a prefetch instruction to the third line and the fourth line inside the “for” loop. “Prefetch(x[i+N])” is an instruction to transfer the (i+N)-th (N>0) element of the array “x” from the memory 3 to the cache memory 6. Similarly, “prefetch(a[i+N])” is an instruction to transfer the (i+N)-th element of the array “a” from the memory 3 to the cache memory 6. Hereinafter, “N” is referred to as a prefetch distance.

By transferring the element that is N ahead of the i-th element, to the cache memory 6 in advance in the i-th process with use of the prefetch instruction, the arithmetic unit 4 does not need to access the memory 3 in the (i+N)-th loop process, and the acceleration in the execution speed of the program is therefore expected.

However, such prefetching does not always accelerate the execution speed of the program.

For example, in the case illustrated in FIG. 2B, “x[i]=a[i]” is executed in the order of i=1, 2, . . . , n. Therefore, the prefetched (i+N)-the elements of the arrays “x” and “a” are always accessed in the future.

However, when the access to the element of the array “a” is random, there may be a case where the (i+N)-th element of the array “a” is not accessed in the future. In this case, even when the (i+N)-th element is prefetched, the arithmetic unit 4 will never use this element, and the acceleration in the execution speed of the program cannot be achieved.

Furthermore, in the prefetch instructions such as “prefetch(x[i+N])” and “prefetch(a[i+N])”, the elements of i=0, 1 . . . , N−1 of each of the arrays “x” and “a” are not prefetched. Therefore, the acceleration in the execution speed in the loop processes of i=0, 1, . . . , N−1 is not expected.

To solve the above problems, a method of generating a prefetch instruction as in the following first to third examples may be considered.

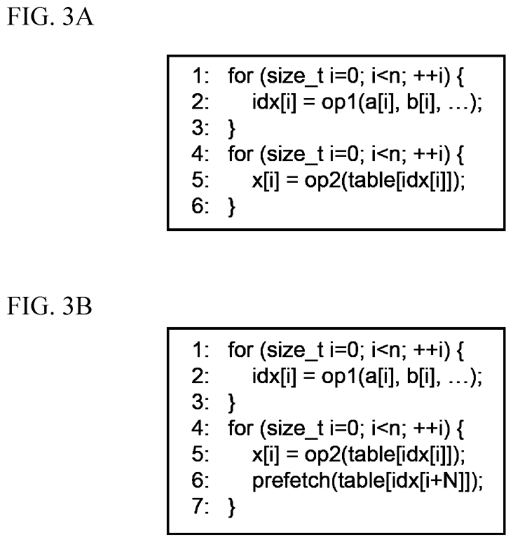

FIG. 3A illustrates a C source code in accordance with a first example before optimized by the compiler.

In the first example, a loop process starting with a for statement exists in the first line and the fourth line. In the preceding loop process of the first line, the result obtained by performing a predetermined operation “op1” on array elements “a[i]” and “b[i]” is assigned to the array element “idx[i]”. Each element of the array “idx” indicates the index of each element of an array “table” that stores elements of a table. Since each array element “idx[i]” is determined by the operation “op1”, respective data elements of “idx[0]”, “idx[1]”, . . . , “idx[n]” are not necessarily aligned serially in the memory 3, and may be aligned randomly in the memory 3.

In the subsequent loop process of the fourth line, the result obtained by performing a predetermined operation “op2” on the table data element “table[idx[i]]” is stored in the array element “x[i]”.

FIG. 3B illustrates a C source code obtained after the compiler optimizes the source code illustrated in FIG. 3A.

In this example, the compiler inserts a prefetch instruction “prefetch(table[idx[i+N]])” to the inside of the subsequent loop process.

In this case, even when the array elements “idx[i]” are aligned randomly, the prefetch instruction “prefetch(table[idx[i+N]])” prefetches “table[idx[i+N]]” that is to be always accessed in the future. Thus, the acceleration in the execution speed of the program can be expected.

However, one load instruction is generated by “idx[i+N]” every time the loop process is executed, the execution time of the program may increase due to the transfer time of the data caused by the load instruction.

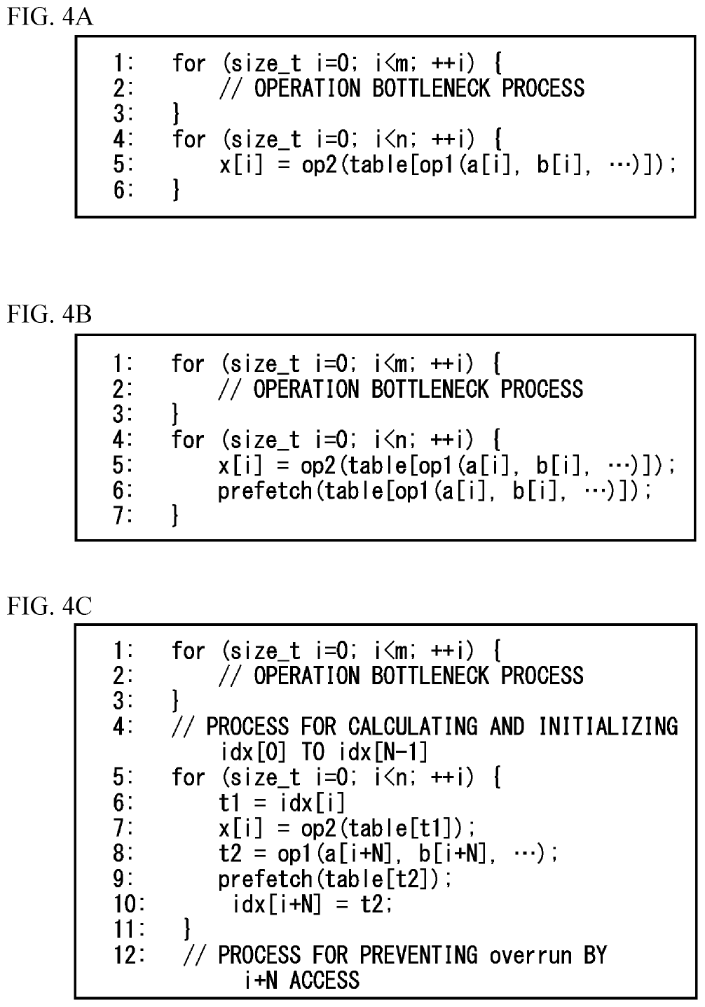

FIG. 4A illustrates a C source code in accordance with a second example before optimized by the compiler.

In the second example, a loop process starting with a for statement exists in the first line and the fourth line as in the first example. However, unlike the first example, the process in which a value is assigned to the index of the array “table” is not executed in the preceding loop process. In addition, inside the preceding loop process, an operation bottleneck process is performed. The operation bottleneck process is a process in which the total number of clock cycles required for the operation process to be executed by the arithmetic unit 4 is greater than the total number of clock cycles required for the arithmetic unit 4 to reference data of the memory 3. The referencing of data is a process in which the arithmetic unit 4 writes data to the memory 3, or a process in which the arithmetic unit 4 reads data from the memory 3.

In the subsequent loop process of the fourth line, the index “op1(a[i], b[i], . . . )” of the table is obtained by the operation “op1”. Further, the result obtained by performing the predetermined operation “op2” on the element “table[op1(a[i], b[i], . . . )]” of the table corresponding to the index “op1(a[i], b[i], . . . )” is stored in the array element “x[i]”.

FIG. 4B is a C source code obtained after the compiler optimizes the source code illustrated in FIG. 4A.

In this example, the compiler inserts a prefetch instruction “prefetch(table[op1(a[i], b[i], . . . )])” to the loop process of the for statement in the fourth line to try to accelerate the execution speed of the program.

However, “op1(a[i], b[i], . . . )” is calculated in the fifth line and the sixth line. Thus, the calculation cost may increase depending on the contents of the operation “op1”.

FIG. 4C illustrates a C source code after the compiler optimizes the source code illustrated in FIG. 4A using a method different from that of FIG. 48.

In this example, the process of the operation “op1” is performed in only one place. “op1(a[i+N], b[i+N], . . . )” in the eighth line, which makes the calculation cost less than that of the case of in FIG. 4B.

However, four arrays “idx”, “x”, “a”, and “table” become necessary inside the subsequent loop process, which results in increase in the number of streams. Here, plural data elements having consecutive addresses in the memory 3, such as array elements, are called one stream. In this example, four streams respectively corresponding to four arrays “idx”, “x”, “a”, and “table” are generated.

As the number of streams increases, the number of memory reference instructions to access each stream increases, which results in resource shortage, and in some cases, only a smaller number of the memory reference instructions than the outstanding number determined by hardware can be issued.

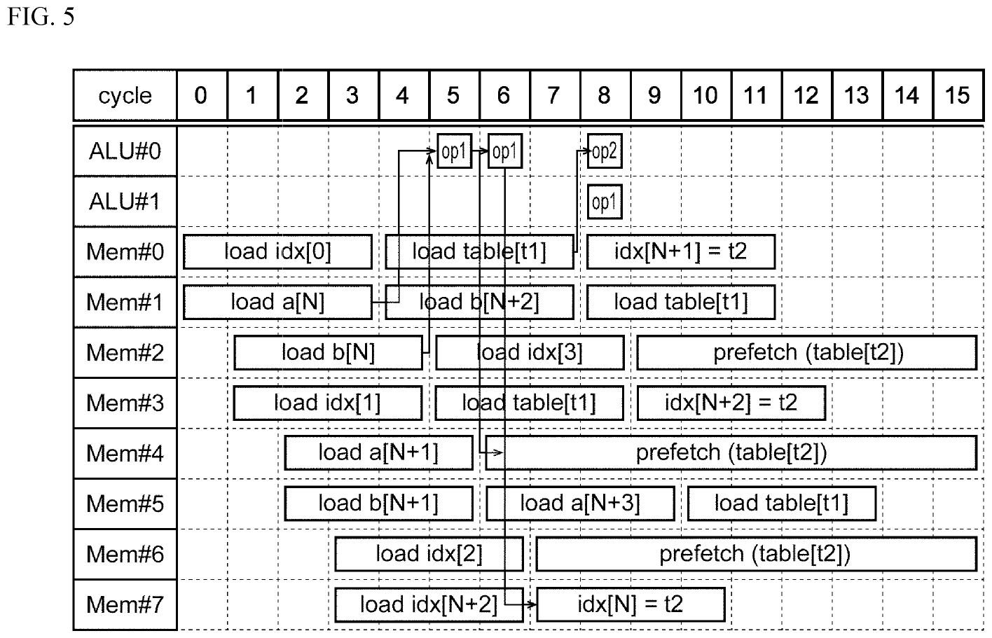

FIG. 5 is a schematic view for describing the outstanding number when the source code of FIG. 4C is executed.

The horizontal axis of FIG. 5 represents the number of clock cycles. Here, a case where two arithmetic units 4 are provided is assumed, and two arithmetic units 4 are expressed by “ALU #0” and “ALU #1”, respectively. In addition, “Mem #0” to “Mem #7” indicate physical paths through which data is transferred from the memory 3 to the cache memory 6. Furthermore, assumed is a case where the processor 2 employs the out-of-order execution architecture, and therefore can issue two operation instructions in the same cycle and issue two memory reference instructions in the same cycle.

In this case, the processor 2 can simultaneously issue up to 8 memory reference instructions such as a store instruction, a load instruction, and a prefetch instruction in the same clock cycle. This number, 8, is the outstanding number.

However, when the large number of memory reference instructions are issued, the memory reference instruction to be issued when the number of clock cycles is 10 becomes only one memory reference instruction “load table[t1]”, which results in decrease in the execution speed of the program.

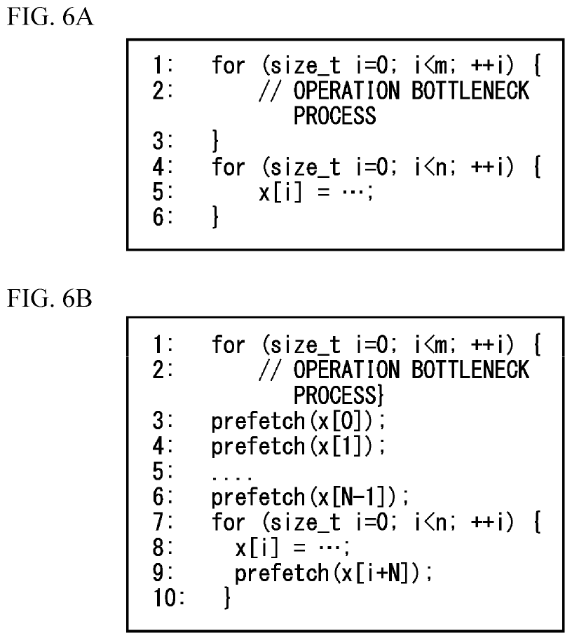

FIG. 6A illustrates a C source code in accordance with the third example before optimized by the compiler.

In this example, a loop process starting with a for statement exists in the first line and the fourth line. The operation bottleneck process is executed inside the preceding loop process.

In addition, in the subsequent loop process, the statement “x[i]= . . . ” in the fifth line causes a store instruction to assign the right-hand value to the i-th element “x[i]” of the array “x” to be executed.

FIG. 6B illustrates a C source code obtained after the compiler optimizes the source code illustrated in FIG. 6A.

In this example, before the loop process of the for statement in the seventh line starts, the compiler inserts “prefetch[0]”, “prefetch[1]” . . . . , “prefetch[N−1]” for prefetching the array elements “x[0]”, “x[1]”, . . . , “x[N−1]” required for the loop process. These prefetch instructions are expected to accelerate the execution speed of the program compared with the case illustrated in FIG. 6A to some extent. Such prefetching is called prologue prefetching.

However, in prologue prefetching, the subsequent loop process in the seventh line cannot be executed until the prefetch instructions “prefetch[0]”, “prefetch[1]”, . . . , “prefetch[N−1]” are completed, and them is room for accelerating the execution speed of the program.

Hereinafter, an embodiment will be described.

### EMBODIMENT

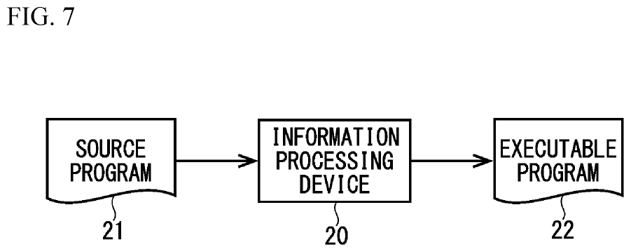

FIG. 7 is a schematic view illustrating a process executed by an information processing device 20 in accordance with the embodiment.

The information processing device 20 is a computing machine such as a personal computer (PC) or a server, and compiles a source program 21 to generate an executable program 22. Although the programing language of the source program 21 is not particularly limited, hereinafter, a case where the source program 21 is written in the C language will be described as an example.

The target machine to execute the executable program 22 is the computing machine 1 (see FIG. 1). As illustrated in FIG. 1, the computing machine 1 includes the cache memory 6, but in this embodiment, the executable program 22 executes prefetching using the cache memory 6 having a sector function. Thus, the sector function will be described first.

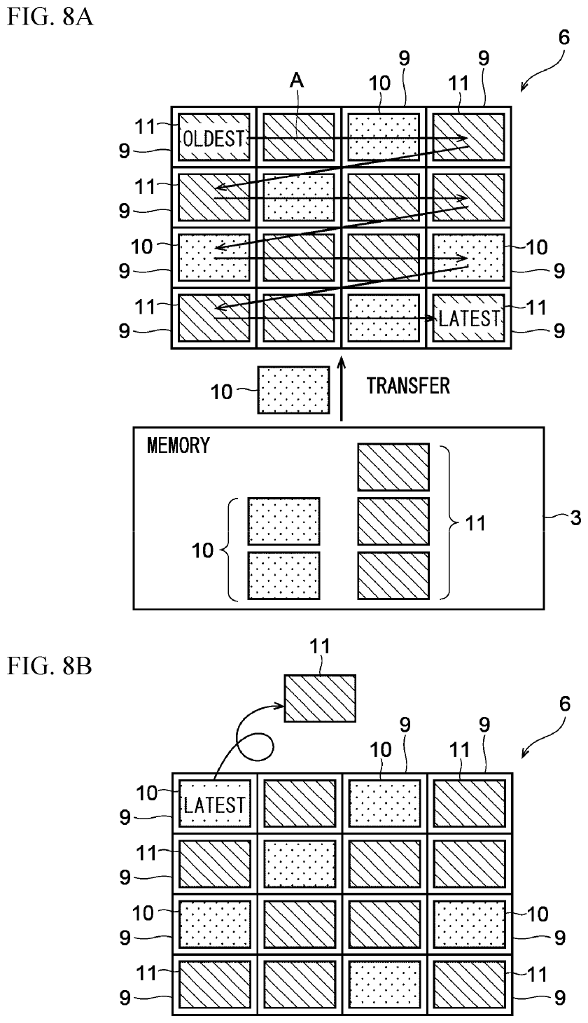

FIG. 8A is a schematic view of the cache memory 6 without a sector function.

As illustrated in FIG. 8A, the cache memory 6 has a plurality of cache lines 9. The cache line 9 is a storage area having a storage capacity of, for example, 128 kBytes. Prefetching of data from the memory 3 to the cache memory 6 is executed for each cache line 9. Similarly, writing of data from the cache memory 6 to the memory 3 is performed for each cache line 9.

Here, a case where stream data 10 and table data 11 in the memory 3 are prefetched to the memory 3 in the order indicated by the arrow A will be described. The stream data 10 is a set of data elements having consecutive addresses in the memory 3, such as a[0], a[i], . . . . The table data 11 is data that is reused by the program.

The entire size (the capacity) of the cache memory 6 is smaller than the capacity of the memory 3. Thus, it is impossible to prefetch all the data in the memory 3 to the cache memory 6. Thus, cache-out is performed to write unnecessary data in the cache memory 6 back to the memory 3. This will be described next.

FIG. 8B is a schematic view for describing cache-out in the cache memory 6 without a sector function.

When the data of the cache memory 6 is cached out, the data is written back to the memory 3 in order from the least recently used data by using, for example, Least Recently Used (LRU). When no sector function is provided, regardless of whether the write-back object is the stream data 10 or the table data 11, the least recently used data is the cache-out object. This example illustrates a case where the table data 11 is cached out by newly prefetching the stream data 10.

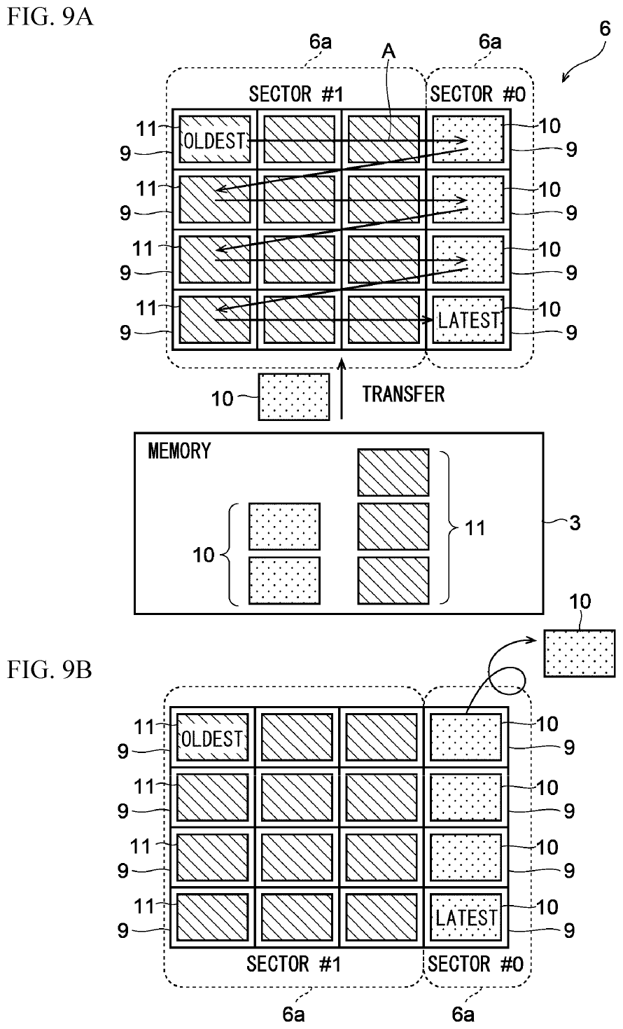

FIG. 9A is a schematic view of the cache memory 6 having a sector function.

In the cache memory 6 having a sector function, the cache memory 6 is divided into storage areas called sectors 6a. Here, the sectors 6a are uniquely identified by the number subsequent to the symbol “#”, such as the “sector #0” and the “sector #1”.

When the sector function is provided, the stream data 10 is stored only in the sector #0, and the stream data 10 is not stored in sectors other than the sector #0. Similarly, the table data 11 is store only in the sector #1, and the table data 11 is not stored in sectors other than the sector #1. The sector #1 is an example of a first sector, and the sector #0 is an example of a second sector.

Here, a case where the stream data 10 and the table data 11 in the memory 3 are prefetched to the memory 3 in the order indicated by the arrow A is illustrated.

FIG. 98 is a schematic view illustrating cache-out in the cache memory 6 having a sector function.

Here, a case where the least recently used data is the table data 11 in the sector #1, and the stream data 10 is newly prefetched from the memory 3 to the cache memory 6 will be discussed. In the cache memory 6 with a sector cache, the data stored in a certain sector is kicked out only by the data in the same sector. Thus, in the above case, the table data 11 in the sector #1 is not kicked out, and the stream data 10 that is least recently used in the sector #0 is cached out to the memory 3.

Next, a compiling method executed by the information processing device will be described. The prefetch method used in the compiling method includes first to third prefetch methods.

First Prefetch Method (all-Index Prefetch)

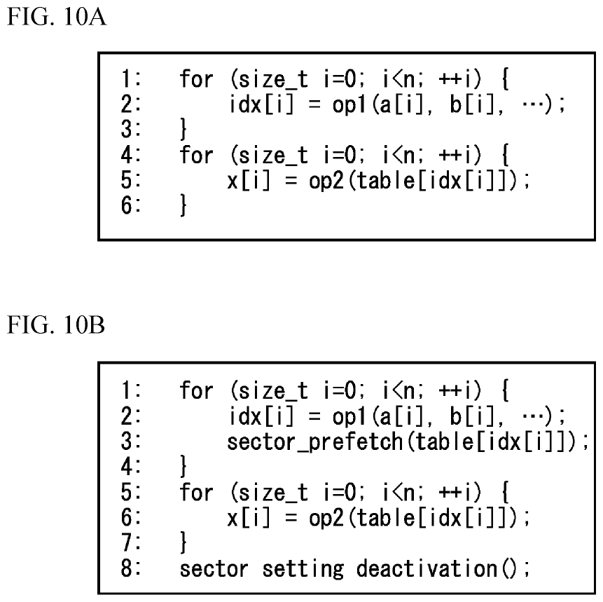

FIG. 10A illustrates a C source code written in the source program 21 before compiled by the information processing device 20. This source code is the same as the source code illustrated in FIG. 3A, and has a preceding loop process starting with a for statement in the first line and a subsequent loop process starting with a for statement in the fourth line. The preceding loop process is an example of a second loop process, and the subsequent loop process is an example of a first loop process.

The preceding loop process is a process in which the indexes “idx[i]” (i=0, 1, . . . , n) of the array “table” representing the table are calculated by the operation “op1”. The subsequent loop process is a process in which the operation “op2” is performed on the elements “table[idx[i]]” (i=0, 1, . . . , n) of the array “table” corresponding to respective indexes “idx[i]” and the operation results are stored in respective elements of the array “x”.

FIG. JOB illustrates a source code obtained after the information processing device 20 optimizes the source code illustrated in FIG. 10A according to the first prefetch method.

In the first prefetch method, the information processing device 20 inserts a prefetch instruction “sector_prefetch(table[idx[i]])” to the preceding loop process. The prefetch instruction “sector_prefetch(table[idx[i]])” is an example of a first instruction, and transfers data elements expressed by “table[idx[i]]” from the memory 3 to the sector #1 of the cache memory 6. This prefetch instruction transfers, from the memory 3 to the cache memory 6, the data elements “table[idx[i]]” corresponding to the indexes “idx[i]” calculated in the preceding loop process among the data elements that are the elements of the array “table”. This prefetch is called all-index prefetch, hereinafter. The data elements that are the elements of the army “table” are examples of first data elements. Data elements other than the data element “table[idx[i]]”, such as “idx[i]”, “a[i]”, and “b[i]”, are examples of a second data element to be prefetched to the sector #0. The data elements “table[idx[i]]” corresponding to the indexes “idx[i]” calculated in the preceding loop process among the data elements that are the elements of the array “table” are examples of third data elements.

When the prefetch instruction “sector_prefetch(table[idx[i]])” is executed, the data in the sector #1 is prohibited from being cached out by data other than the elements of the array “table” representing the table. “Sector setting deactivation” in the eighth line is an instruction to deactivate this prohibition. The same applies to the second prefetch method and the third prefetch method described later.

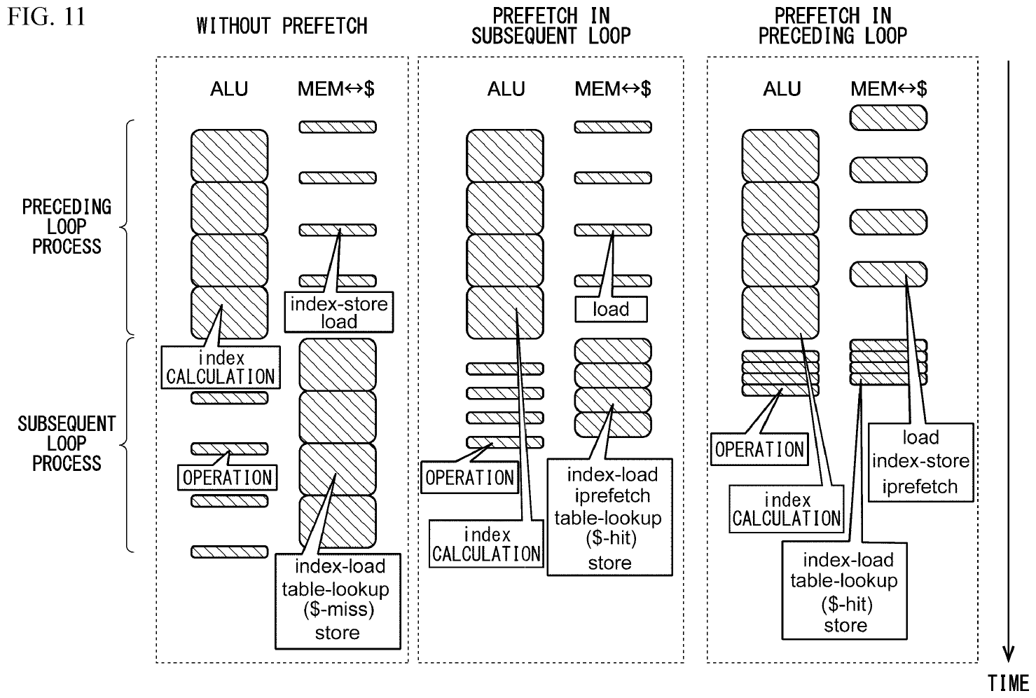

FIG. 11 is a schematic view illustrating an advantage achieved by the first prefetch method (all-index prefetch).

In this example, the period during which the arithmetic unit 4 performs an operation is indicated by a hatched rectangle below “ALU)”. This period will be sometimes referred to as an operation cost, hereinafter. A hatched rectangle below “MEM↔$” indicates the period during which data is transferred from the memory 3 to the cache memory 6. This period will be sometimes referred to as a memory cost, hereinafter. In FIG. 11 and FIG. 13 and FIG. 15 described later, time flows from the top to the bottom of the paper.

“Without prefetch” indicates a case where the executable program obtained from the source code of FIG. 10A, which is not optimized, is executed in the computing machine 1. In this case, the data element “table[idx[i]]” may be absent in the cache memory 6 at the time of executing the load instruction required for the operation “op2(table[idx[i]])” in the fifth line in FIG. 10A. In this case, a cache miss occurs, which results in increase in the memory cost and increase in the execution time of the executable program 22 in the computing machine 1.

“Prefetch in subsequent loop” indicates a case where the executable program obtained from the optimized source code as illustrated in FIG. 38 is executed in the computing machine 1. In this case, as described above, the load instruction is generated every time the subsequent loop process of FIG. 3B is executed, and the execution time of the program increases due to the transfer time of the data caused by the load instruction.

“Prefetch in preceding loop” indicates a case where the executable program obtained from the source code optimized using the first prefetch method (all-index prefetch) illustrated in FIG. 10B is executed in the computing machine 1. As illustrated in FIG. 10B, prefetching is not executed in the subsequent loop in this case. Thus, compared with the case “prefetch in subsequent loop”, the memory cost in the subsequent loop process is reduced.

This reduced memory cost is added to the execution time of the load instruction required for the prefetch instruction “sector_prefetch(table[idx[i]])” of the preceding loop process. However, when the preceding loop process executes the operation bottleneck process, the execution time of the load instruction can be hidden in the operation cost, which prevents the increase in the execution time of the preceding loop process.

As a result, the first prefetch method (all-index prefetch) described in FIG. 108 can reduce the execution time of the executable program 22 compared with the cases “without prefetch” and “prefetch in preceding loop”.

In addition, the prefetch instruction “sector_prefetch(table[idx[i]])” is an instruction to prefetch the elements (table[idx[i]]) of the table to the sector #1 of the cache memory 6. Therefore, the elements (table[idx[i]]) prefetched to the sector #1 are not cached out by array elements other than the elements of the table until the subsequent loop process is completed, which increases the cache hit ratio.

### Second Prefetch Method (Whole-Table Prefetch)

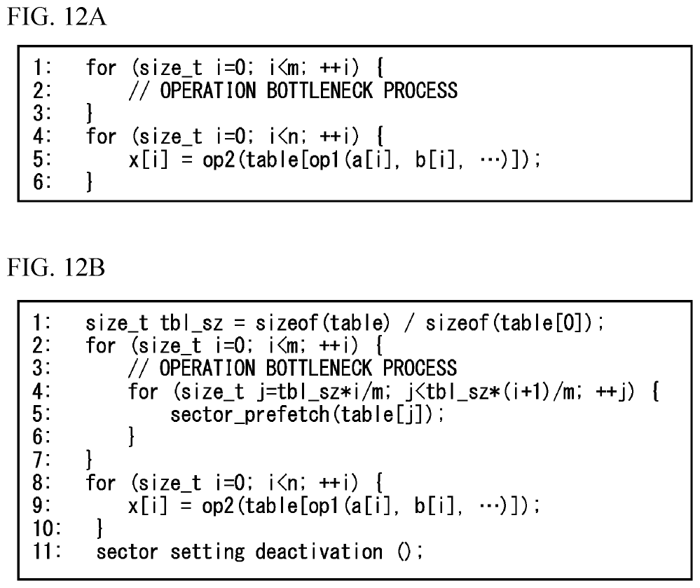

FIG. 12A illustrates a C source code written in the source program 21 before compiled by the information processing device 20. This source code is the same as the source code of FIG. 4A, and has a preceding loop process starting with a for statement in the first line and a subsequent loop process starting with a for statement in the fourth line. The preceding loop process is an example of a second loop process, and the subsequent loop process is an example of a first loop process.

The preceding loop process executes the operation bottleneck process. The subsequent loop process executes a process in which the operation “op2” is performed on the element “table[op1(a[i], b[i], . . . )]” of the array “table” representing the table and the operation result is stored in in the element “x[i]” of the array “x”.

Accordingly, the elements of the array “table” that am subject to the operation “op2” are determined by the results of the operation “op1”. Thus, which elements are subject to the operation “op2” among all the elements of “table” are unknown in advance.

FIG. 128 illustrates a source code obtained after the information processing device 20 optimizes the source code of FIG. 12A according to the second prefetch method.

In the second prefetch method, the information processing device 20 inserts a prefetch instruction “sector_prefetch(table[j])” to the preceding loop process. The prefetch instruction “sector_prefetch(table[j])” is an example of a second instruction, and is an instruction to transfer the data of all the elements of the array “table” from the memory 3 to the sector #1 of the cache memory 6. This prefetch is referred to as whole-table prefetch, hereinafter. The data elements “table[j]” to be prefetched to the sector #1 as described above are examples of first data elements. Data elements other than the data element “table[j]”, such as “a[i]”, “b[i]”, and “x[i]”, are examples of a second data element to be prefetched to the sector #0.

Accordingly, even when the elements of the array “table” subject to the operation “op2” are unknown in advance, all the elements of the array “table” are prefetched in the preceding loop process, and thereby, occurrence of cache misses in the subsequent loop process is prevented.

Additionally, the prefetch instruction “sector_prefetch(table[j])” is an instruction to prefetch the elements (table[j]) of the table to the sector #1 of the cache memory 6. Thus, the elements (table[j]) that have been prefetched to the sector #1 are not cached out by array elements other than the elements of the table until the subsequent loop process is completed, which increases the cache hit ratio.

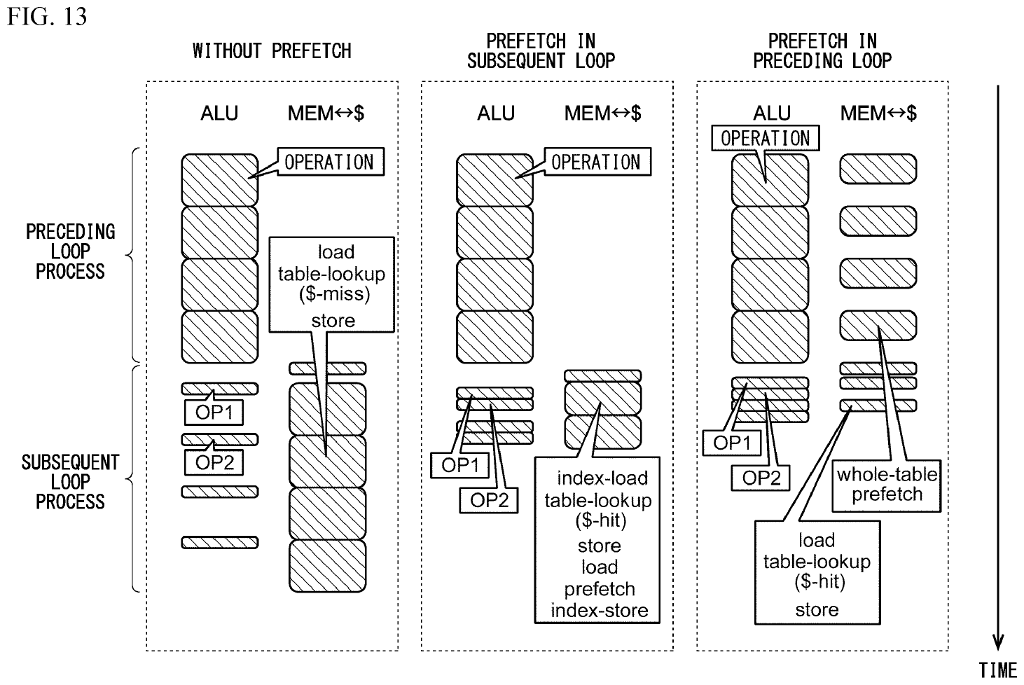

FIG. 13 is a schematic view illustrating an advantage achieved by the second prefetch method (whole-table prefetch).

“Without prefetch” in FIG. 13 indicates a case where the executable program obtained from the source code of FIG. 12A, which is not optimized, is executed in the computing machine 1. In this case, the data element “table[op1(a[i], b[i], . . . )]” may be absent in the cache memory 6 at the time of executing the load instruction required for the operation “op2(table[op1(a[i], b[i], . . . )])” in the fifth line of FIG. 12A. In this case, a cache miss occurs, which results in increase in the memory cost and increase in the execution time of the executable program 22 in the computing machine 1.

“Prefetch in subsequent loop” indicates a case where the executable program obtained from the optimized source code as illustrated in FIG. 4C is executed in the computing machine 1. In this case, as mentioned above, since the number of streams in the subsequent loop process increases, only a smaller number of memory reference instructions than the outstanding number may be issued. In such a case, the memory cost increases.

“Prefetch in preceding loop” indicates a case where the executable program obtained from the source code optimized using the second prefetch method (whole-table prefetch) illustrated in FIG. 12B is executed in the computing machine 1. As with the first prefetch method, prefetching is not executed in the subsequent loop in this case, and therefore, the memory cost in the subsequent loop process can be reduced.

In addition, the reduced memory cost is added to the execution time of the load instruction required for the prefetch instruction “sector_prefetch(table[j])” of the preceding loop process. However, in this example, since the preceding loop process executes the operation bottleneck process, the execution time of the load instruction can be hidden in the operation cost, and the increase in the execution time of the preceding loop process is prevented.

As a result, the second prefetch method (whole-table prefetch) of FIG. 12B can reduce the execution time of the executable program 22 compared with the cases “without prefetch” and “prefetch in preceding loop”.

### Third Prefetch Method (Better-Prologue Prefetch)

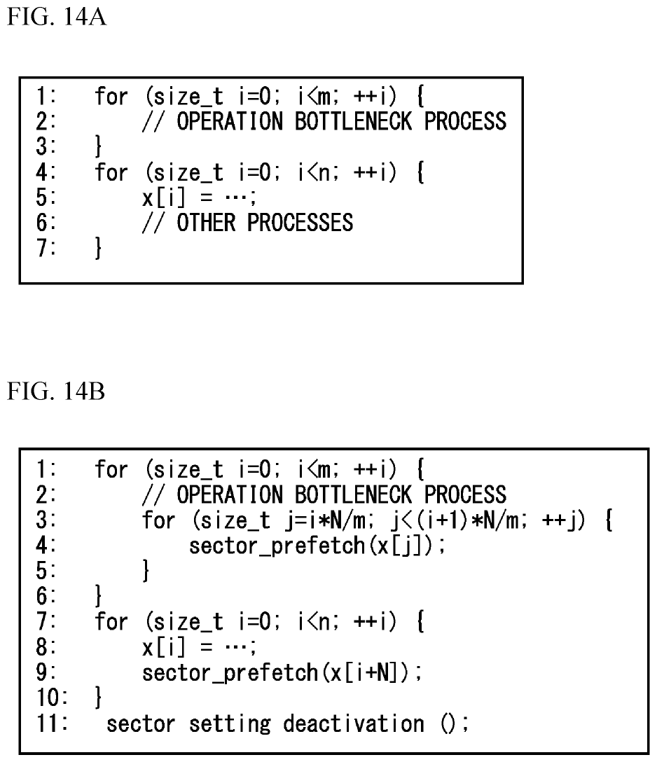

FIG. 14A illustrates a C source code written in the source program 21 before compiled by the information processing device 20. This source code is the same as the source code of FIG. 6A, and has a preceding loop process starting with a for statement in the first line and a subsequent loop process starting with a for statement in the fourth line. The preceding loop process is an example of a second loop process, and the subsequent loop process is an example of a first loop process.

The preceding loop process executes the operation bottleneck process. The subsequent loop process is a process in which a predetermined value is assigned to each element “[i]” of the array “x”. The addresses of the elements of the array in the memory 3 are consecutive. Thus, the elements “x[i]” are contiguous to each other in the memory 3.

FIG. 148 illustrates a source code obtained after the information processing device 20 optimizes the source code of FIG. 14A according to the third prefetch method.

In the third prefetch method, the information processing device 20 inserts a prefetch instruction “sector_prefetch(x[j])” to the preceding loop process. This prefetch instruction “sector_prefetch(x[j])” is an example of a third instruction, and an instruction to transfer, from the memory 3 to the sector #1 of the cache memory 6, the data of the elements “x[i]” contiguous to each other in the memory 3. Additionally, the information processing device 20 inserts a prefetch instruction “sector_prefetch(x[i+N])” to the subsequent loop process. This prefetch is referred to as better-prologue prefetch, hereinafter. The data elements “[i]” to be prefetched to the sector #1 are examples of first data elements. In addition, data elements other than “x[i]” are examples of a second data element to be prefetched to the sector #0.

Accordingly, the elements “x[i]” required for execution of the statement “x[i]= . . . ;” in the eighth line are transferred from the memory 3 to the cache memory 6 in advance in the preceding loop process, which prevents occurrence of cache misses in the subsequent loop process. Further, in the prefetch instruction “sector_prefetch(x[i+N])” in the subsequent loop process, the element “x[i+N]”, which is N ahead of the element “x[i]”, is prefetched. This also prevents cache misses.

Further, the prefetch instruction “sector_prefetch(x[j])” and “sector_prefetch(x[i+N])” are instructions to prefetch the elements of the array “x” to the sector #1 of the cache memory 6. Thus, the elements of the array “x” prefetched to the sector #1 are not cached out by array elements other than the elements of the array “x” until the subsequent loop process is completed, which increases the cache hit ratio.

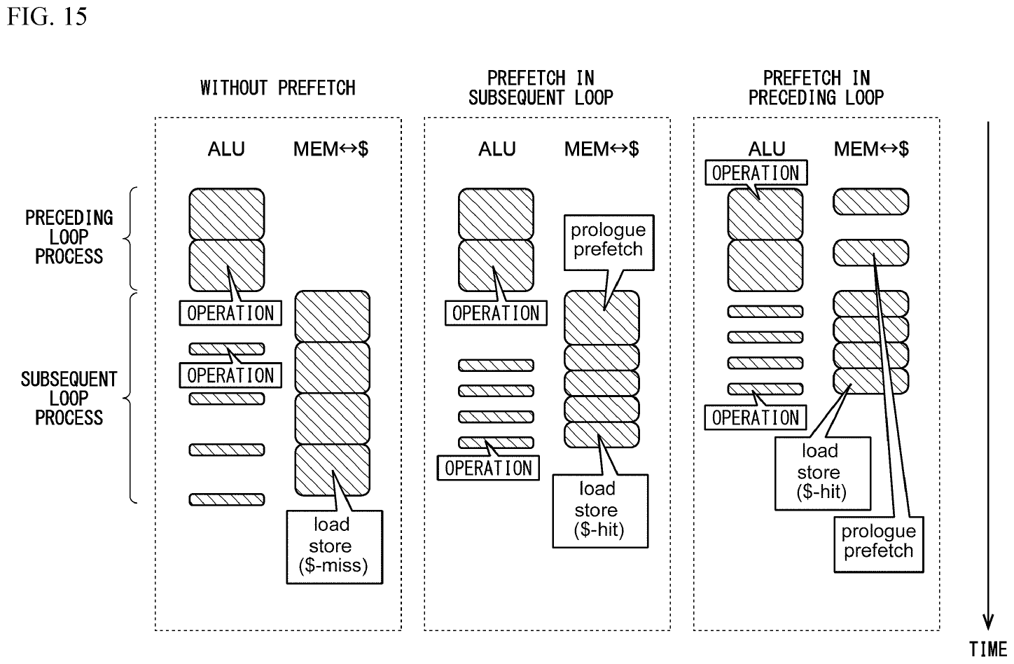

FIG. 15 is a schematic view illustrating an advantage achieved by the third prefetch method (better-prologue prefetch).

“Without prefetch” in FIG. 15 indicates a case where the executable program obtained from the source code of FIG. 14A, which is not optimized, is executed in the computing machine 1. In this case, the data element “x[i]” may be absent in the cache memory 6 at the time of executing the load instruction and the store instruction required for the statement “x[i]= . . . ;” in the fifth line of FIG. 14A. In this case, a cache miss occurs, which results in increase in the memory cost and increase in the execution time of the executable program 22 in the computing machine 1.

“Prefetch in subsequent loop” indicates a case where the executable program obtained from the source code optimized by prologue prefetch as illustrated in FIG. 6B is executed in the computing machine 1. In prologue prefetch, the subsequent loop process is kept waiting until the prefetch instructions “prefetch[0]”, “prefetch[1]”, . . . , “prefetch[N−1]” are completed after the completion of the preceding loop process. Thus, there are limitations to acceleration in the execution time of the program.

“Prefetch in preceding loop” indicates a case where the executable program obtained from the source code optimized by the third prefetch method (better-prologue prefetch) illustrated in FIG. 148 is executed in the computing machine 1. In this case, since the prefetch instruction “sector_prefetch(x[j])” is executed in the preceding loop process, the subsequent loop process is not kept waiting after completion of the preceding loop process.

Furthermore, since the preceding loop process executes the operation bottleneck process, the execution time of the prefetch instruction “sector_prefetch(x[j])” can be hidden in the operation cost of the preceding loop process, which prevents the increase in the execution time of the preceding loop process.

As a result, the third prefetch method (better-prologue prefetch) of FIG. 148 can reduce the execution time of the executable program 22 compared with the cases “without prefetch” and “prefetch in preceding loop”.

In the present embodiment, there are the first to third prefetch methods as described above. Which prefetch method is selected among the first to third prefetch methods is determined by the information processing device 20 based on the access pattern in the subsequent loop process as follows.

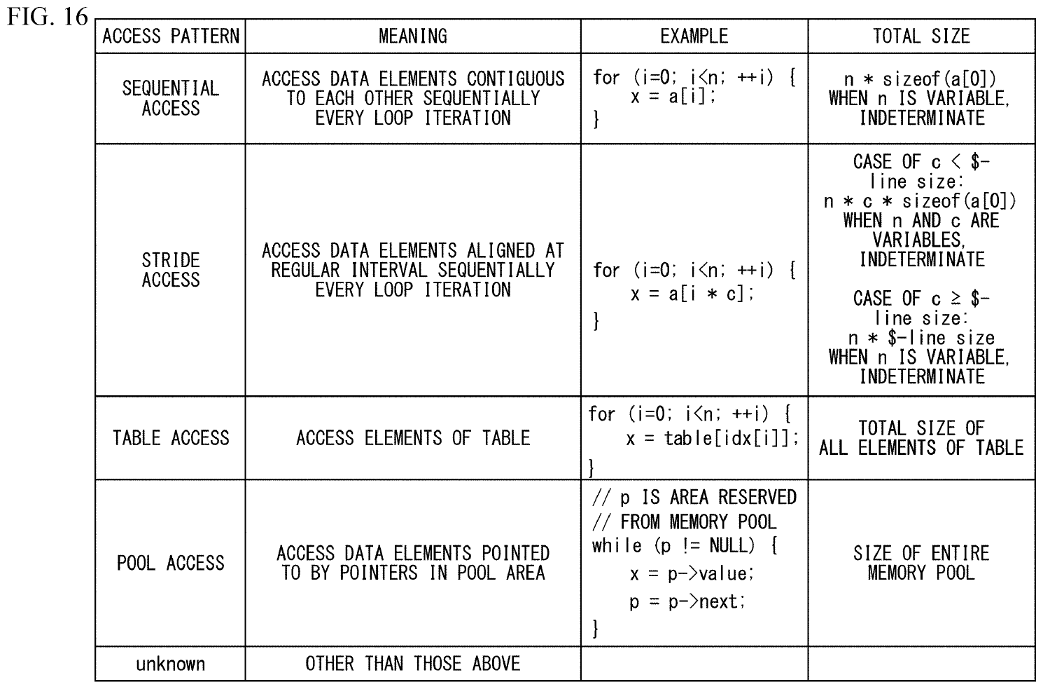

FIG. 16 is a diagram for describing the access pattern.

The access pattern indicates how a memory reference instruction such as a load instruction and a store instruction accesses a plurality of data elements in the memory 3 every loop iteration. In the present embodiment, a sequential access, a stride access, a table access, and a pool access are assumed as the access pattern. Patterns other than these patterns are defined as unknown.

In FIG. 16, the total size of the areas to be reserved in the cache memory 6 when data elements are prefetched in each access pattern is also presented.

The sequential access is a pattern in which the memory reference instruction sequentially accesses a plurality of data elements contiguous to each other in the memory 3 every loop iteration. For example, the pattern in which the array elements are accessed sequentially is the sequential access.

When the sequential access is applied to the array “a” in the loop process of which the loop iteration number is the constant n, the total size is n*seizeof(a[0]). “Sizeof” is the function that returns the size of the array element “a[0]”. When the loop iteration number n is a variable, the total size is indeterminate.

The stride access is a pattern in which the memory reference instruction sequentially accesses a plurality of data elements aligned at regular intervals in the memory 3 every loop iteration. For example, the pattern in which the array elements corresponding to the indexes that are a multiple of the integer c are accessed is the stride access.

The total size in the case of the stride access differs depending on the magnitude relationship between the integer c and the size S-line size of the cache line. For example, when c<$-line size and the integer c and the loop iteration number n are constants, the total size is n*c*sizeof(a[0]). When the integer c and the loop iteration number are both variables, the total size is indeterminate.

By contrast, when c≥$-line size and the loop iteration number n is a constant, the total size is n*S-line size. When the loop iteration number n is a variable, the total size is indeterminate.

The table access is a pattern in which the elements of the table stored in the memory 3 are accessed. It is impossible for the information processing device 20 to identify the index of the element to be accessed in advance. Thus, the table access needs to reserve the total size of all the elements of the table in the cache memory 6.

The pool access is a pattern in which data elements pointed to by pointers in the pool area reserved in the memory 3 are accessed. In this case, the total size is the size of the entire memory pool.

Next, the method of selecting the first to third prefetch methods based on the access pattern will be described for the following cases 1 to 3.

### Case 1

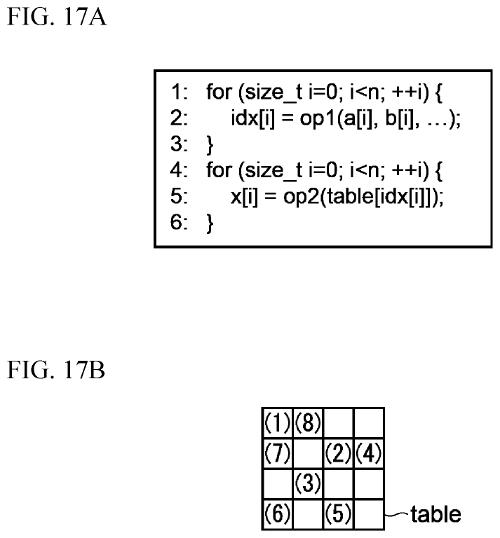

FIG. 17A illustrates an example of a source code in the case 1. This source code is the same as the source code in FIG. 10A.

The case 1 is a case where the access pattern of the subsequent loop process is the table access, and the preceding loop process is a process in which the indexes of the table are calculated. In FIG. 17A, the array “table” represents the table, and each element of the array “idx” represents the index.

FIG. 17B is a schematic view of the entire table.

In this example, a case where the table represented by the array “table” has 16 elements is assumed. In addition, 8 elements indicated by (1) to (8) of the 16 elements are accessed in the subsequent loop process. The numbers (1) to (8) indicate the order in which the elements are accessed in the subsequent loop process.

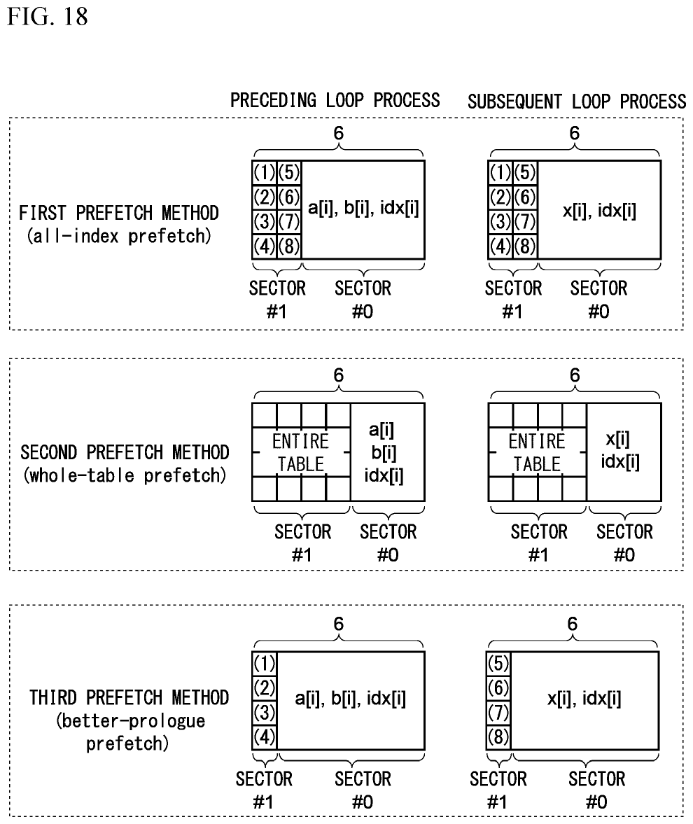

FIG. 18 schematically illustrates the cache memory 6 at the time of executing each of the preceding loop process and the subsequent loop process when the first to third prefetch methods are executed in the case 1.

In the case 1, the indexes of the table are calculated in the preceding loop process, and only the elements corresponding to the calculated indexes are accessed in the subsequent loop process. Thus, the second prefetch method (whole-table prefetch), which prefetches all the elements of the table, wastes the cache memory 6, and thus is not employed.

In the third prefetch method (better-prologue prefetch), the elements of (1) to (4) are prefetched in the preceding loop process, and the elements of (5) to (8) are prefetched in the subsequent loop process. Since the memory cost associated with switching of the elements as described above is generated, the priority of the third prefetch method (better-prologue prefetch) is low.

As clear from above, in the case 1, the information processing device 20 selects the first prefetch method (all-index prefetch). However, when the memory size of the cache memory 6 is not enough, the information processing device 20 selects the third prefetch method (better-prologue prefetch).

### Case 2

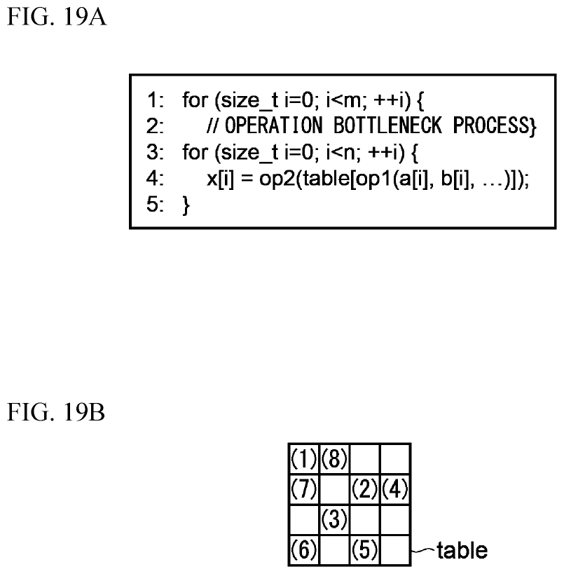

FIG. 19A illustrates an example of a source code in the case 2. This source code is the same as the source code in FIG. 12A.

The case 2 is a case where the access pattern of the subsequent loop process is the table access. The elements of the table to be accessed by the subsequent loop process are unknown in advance. For example, in this source code, the elements to be accessed by the subsequent loop process are determined by the results of the operation “op1(a[i], b[i])”, and am unknown until the operation “op1(a[i], b[i])” is performed.

FIG. 19B is a schematic view of the entire table.

As in FIG. 17B, a case where the table represented by the array “table” has 16 elements is assumed. In addition, 8 elements indicated by (1) to (8) of the 16 elements are accessed in the subsequent loop process. The numbers (1) to (8) indicate the order in which the elements are accessed in the subsequent loop process.

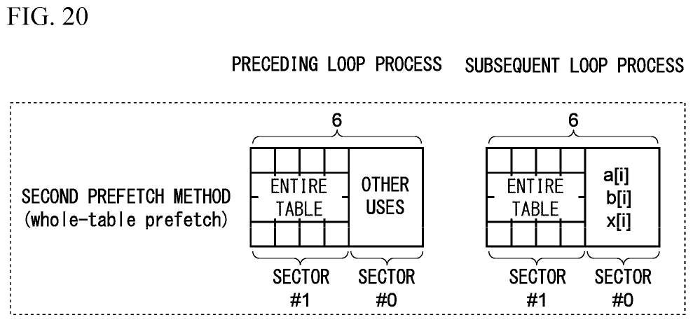

FIG. 20 schematically illustrates the cache memory 6 at the time of executing each of the preceding loop process and the subsequent loop process when the second prefetch method (whole-table prefetch) is executed in the case 2.

In the case 2, as mentioned above, the elements of the table to be accessed by the subsequent loop process are unknown at the time of executing the preceding loop process. Thus, in the case 2, the information processing device 20 employs the second prefetch method (whole-table prefetch) to prefetch all the elements of the table in the preceding loop process.

Also in a case where the access pattern of the subsequent loop process is the pool access, the data elements to be accessed are unknown in advance. Thus, as in the above case 2, the information processing device 20 employs the second prefetch method (whole-table prefetch).

### Case 3

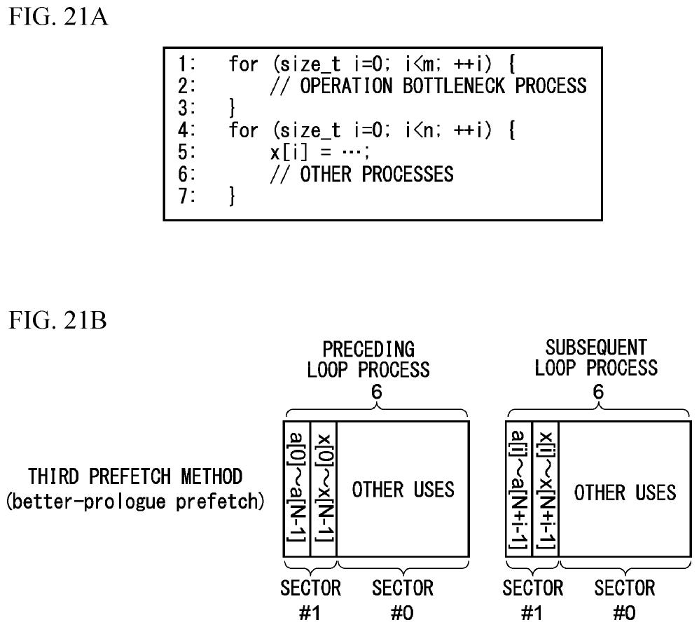

FIG. 21A illustrates a source code in the case 3. This source code is the same as the source code in FIG. 14A.

The case 3 is a case where the access pattern of the subsequent loop process is the sequential access.

FIG. 21B is a schematic view of the cache memory 6 at the time of executing each of the preceding loop process and the subsequent loop process when the third prefetch method (better-prologue prefetch) is performed in the case 3.

In the case 3, the subject to be accessed by the subsequent loop process is not the element of the table. Thus, it is impossible to use the first prefetch method and the second prefetch method, which prefetch the element of the table. Therefore, the information processing device 20 employs the third prefetch method (better-prologue prefetch).

When data elements are prefetched from the memory 3 to the cache memory 6, the area having a size capable of storing the prefetched data elements is required in the cache memory 6. When it is impossible to reserve such an area, degeneration is performed between two prefetch methods as follows.

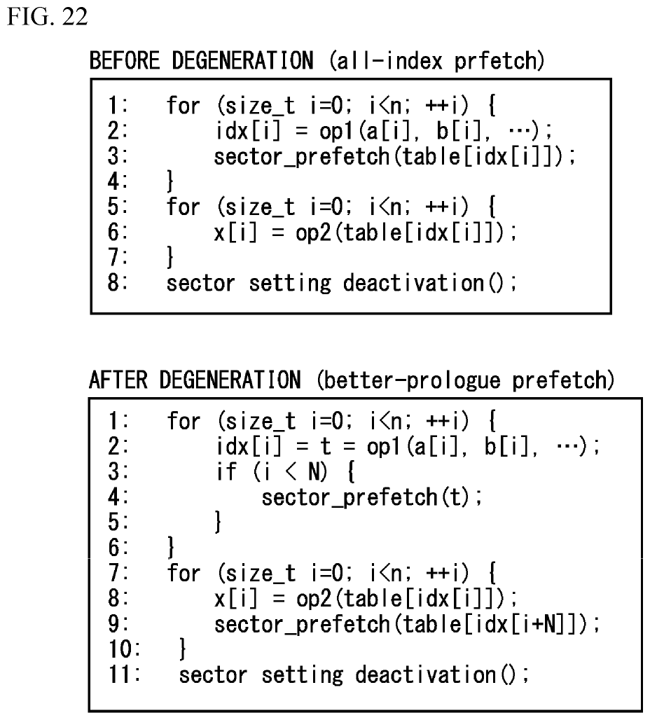

FIG. 22 illustrates a source code before degeneration and a source code after degeneration when the first prefetch method (all-index prefetch) is degenerated to the third prefetch method (better-prologue prefetch).

As illustrated in FIG. 22, in the source code before degeneration, the prefetch instruction (sector_prefetch(table[idx[i]])) is executed in the preceding loop process. A ease where the cache memory 6 does not have an area having a size capable of storing all the data elements to be prefetched by this prefetch instruction is discussed.

In this case, the information processing device 20 reduces the number of the prefetch instructions (sector_prefetch(table[idx[i]])) in the fourth line executed in the preceding loop process to less than the number before degeneration. In this example, the information processing device 20 leaves only the prefetch instructions (sector_prefetch(table[idx[i]])) of i<N by an if statement in the third line, and deletes the prefetch instructions (sector_prefetch(table[idx[i]])) of i≥N from the preceding loop process. Note that N is a prefetch distance smaller than the loop iteration number n.

Additionally, the information processing device 20 inserts a prefetch instruction (sector_prefetch(table[idx[i+N]])) to the ninth line of the subsequent loop process. This prefetch instruction is an instruction to transfer the element of the table corresponding to the index “idx[i+N]” larger than all of the indexes “idx[i]” calculated in the preceding loop process, from the memory 3 to the cache memory 6. The prefetch instruction (sector_prefetch(table[idx[i+N]])) is an example of a fourth instruction.

Through the above process, the first prefetch method (all-index prefetch) is degenerated to the third prefetch method (better-prologue prefetch). The degeneration is a manipulation that replaces a certain prefetch method with another prefetch method that is expected to use less cache memory. The degeneration in accordance with this example is an example of a second manipulation.

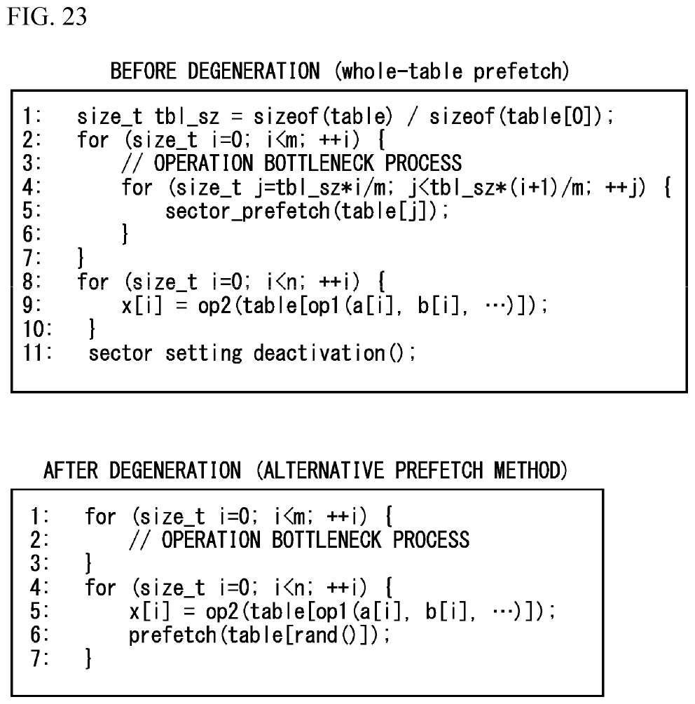

FIG. 23 illustrates a source code before degeneration and a source code after degeneration when the second prefetch method (whole-table prefetch) is degenerated to an alternative prefetch method.

As illustrated in FIG. 23, in the source code before degeneration, the prefetch instruction (sector_prefetch(table[j])) is executed in the preceding loop process. A case where the cache memory 6 does not have an area having a size capable of storing all the data elements to be prefetched by this prefetch instruction is discussed.

In this case, the information processing device 20 deletes the prefetch instruction (sector_prefetch(table[j])) from the preceding loop process. Additionally, the information processing device 20 inserts a prefetch instruction (prefetch(table[rand( )])) to the subsequent loop process. This prefetch instruction (prefetch(table[rand( )])) is an instruction to transfer the element having an index equal to the random number generated by the function “rand( )” of the table, from the memory 3 to the sector #0 of the cache memory 6. This prevents cache misses when the index of the element accessed in the subsequent loop process is incidentally equal to the random number. The prefetch instruction (prefetch(table[rand( )])) is an example of a fifth instruction.

Through the above process, the second prefetch method (whole-table prefetch) is degenerated to an alternative prefetch method using the random number. The degeneration in accordance with this example is an example of a first manipulation.

The functional configuration of the information processing device 20 in accordance with the embodiment will be described.

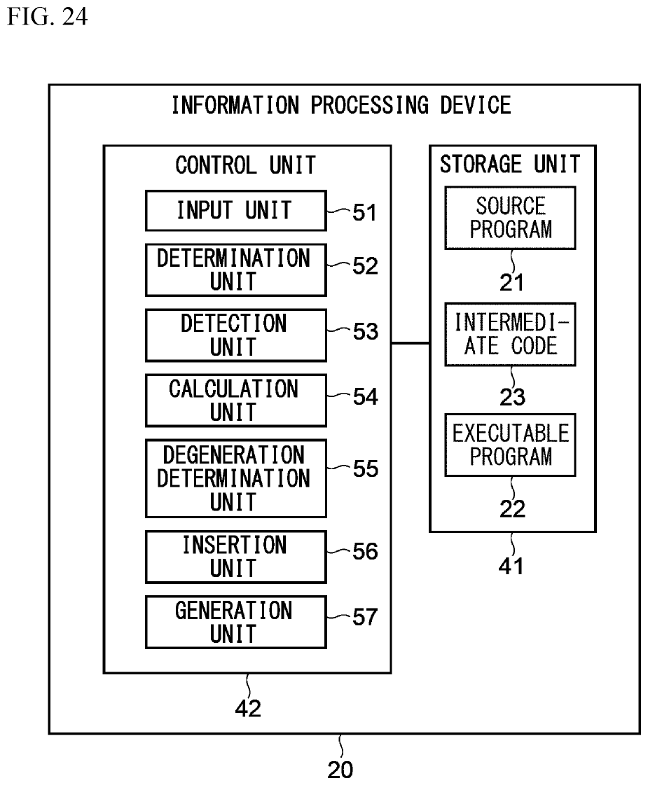

FIG. 24 is a functional block diagram of the information processing device 20.

As illustrated in FIG. 24, the information processing device 20 includes a storage unit 41 and a control unit 42.

The storage unit 41 stores the source program 21, the executable program 22, and an intermediate code 23. The intermediate code 23 is a source code obtained by optimizing the source program 21 according to the first to third prefetch methods. For example, the source codes illustrated in FIG. 10B, FIG. 12C, and FIG. 14B are examples of the intermediate code 23.

The executable program 22 is a binary program executable in the computing machine 1 of FIG. 1.

The control unit 42 is a processing unit that controls each unit of the information processing device 20, and includes an input unit 51, a determination unit 52, a detection unit 53, a calculation unit 54, a degeneration determination unit 55, an insertion unit 56, and a generation unit 57.

The input unit 51 is a processing unit that receives the input of the source program 21, and stores the source program 21 in the storage unit 41. As an example, the input unit 51 receives the input of the source program 21 stored in a recording medium such as a compact disc read only memory (CD-ROM), a digital versatile disc (DVD), or a universal serial bus (USB) memory. The input unit 51 may receive the input of the source program 21 from the external device through the communication with a network such as a local area network (LAN) and the Internet.

In this example, the source program 21 includes a preceding loop process and a subsequent loop process as in the source codes illustrated in FIG. 10A, FIG. 12A, and FIG. 14A.

The determination unit 52 is a processing unit that determines whether the preceding loop process includes the operation bottleneck process. As mentioned above, the operation bottleneck process is a process where the total number of clock cycles required for an operation process executed by the arithmetic unit 4 is larger than the total number of clock cycles required for the access to the memory 3.

The detection unit 53 is a processing unit that detects the access pattern in the subsequent loop process written in the source program 21. As illustrated in FIG. 16, the access pattern includes the sequential access, the stride access, the table access, the pool access, and unknown.

The calculation unit 54 is a processing unit that calculates the total size of the data elements to be transferred from the memory 3 to the cache memory 6 by prefetching.

The degeneration determination unit 55 is a processing unit that determines the degeneration of the prefetch method when it is impossible to reserve an area having a size capable of storing the prefetched data elements in the cache memory 6.

The insertion unit 56 is a processing unit that inserts the prefetch instruction based on the access pattern detected by the detection unit 53 into the preceding loop process. Additionally, the insertion unit 56 stores, as the intermediate code 23, the source program 21 to which the prefetch instruction has been inserted, in the storage unit 41.

The generation unit 57 is a processing unit that generates an object file from the intermediate code 23 and links the necessary library to the object file to generate the executable program 22. Then, the generation unit 37 stores the generated executable program 22 in the storage unit 41.

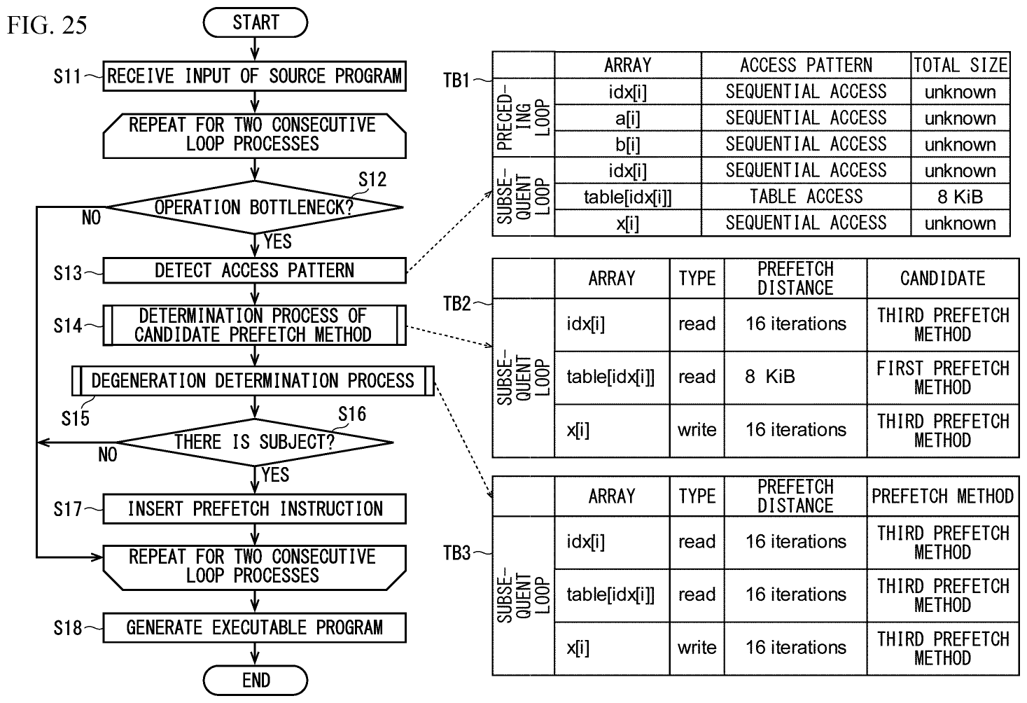

FIG. 25 is a flowchart of a compiling method in accordance with the embodiment.

First, the input unit 31 receives the input of the source program 21 and stores the source program 21 in the storage unit 41 (step S11).

After this step, each step is performed for a pair of two consecutive loop processes in the source program 21.

First, the determination unit 52 determines whether the preceding loop process of the two loop processes includes the operation bottleneck process (step S12). Here, when it is determined that no operation bottleneck process is included (step S12: NO), step S12 is performed again for the subsequent two consecutive loop processes.

When it is determined that the operation bottleneck process is included (step S12: YES), the process proceeds to step S13.

In step S13, the detection unit 53 detects the access pattern in the subsequent loop process. Additionally, the detection unit 53 generates an access pattern table TB1 indicating the detected access patterns, and stores the access pattern table TB1 in the storage unit 41.

The access pattern table TB1 is a table that relates each of the arrays included in the preceding loop process and the subsequent loop process to the access pattern and the total size of the array. In the case of the table access, the total size is the total size of all the elements included in the table. The total size of the access pattern other than the table access is not known, and becomes “unknown”.

Then, the detection unit 53 executes a determination process in which the candidate prefetch method is determined from among the first to third prefetch methods with respect to each array of the subsequent loop process based on the access pattern table TB1 (step S14). For example, the detection unit 53 analyzes which of the cases 1 to 3 (FIG. 17 to FIG. 21) the process contents of the preceding loop process and the subsequent loop process correspond, based on the access pattern table TB1. Then, the detection unit 53 determines the candidate prefetch method based on the analysis result.

For example, the access patterns of the arrays “idx[i]” and “x[i]” are the sequential access. Therefore, when there is any one of the arrays “idx[i]” and “x[i]” in the subsequent loop process, this case corresponds to the case 3 (FIG. 21A). In this case, the detection unit 53 selects the third prefetch method (better-prologue prefetch) as the candidate prefetch method for the arrays “idx[i]” and “x[i]”.

A case where the subsequent loop process includes the array “table[idx[i]]” of which the access pattern is the table access, and the preceding loop process includes the array “idx[i]” representing the index of the table is discussed. This situation corresponds to the case 1 (FIG. 17A). Therefore the detection unit 53 selects the first prefetch method (all-index prefetch) as the candidate prefetch method for the array “table[idx[i]]”.

Then, the detection unit 53 generates a candidate table TB2 indicating candidates selected as described above, and stores die candidate table TB2 in the storage unit 41. The candidate table TB2 is a table that relates the array subject to prefetch in the subsequent loop process, the type of prefetch, the prefetch distance, and the candidate prefetch method to each other. The prefetch type indicates whether the process to the array is read or write.

Then, the degeneration determination unit 55 executes a degeneration determination process in which whether the prefetch method in the candidate table TB2 is to be degenerated is determined with respect to each array, and stores a determination table TB3 indicating the determination results in the storage unit 41 (step S15).

The determination table TB3 is a table that relates the array subject to prefetch in the subsequent loop process, the prefetch type, the prefetch distance, and the determined prefetch method to each other.

For example, when it is impossible to reserve an area having a size capable of storing the prefetched data elements in the cache memory 6, the degeneration determination unit 55 determines degeneration. In this example, illustrated is a case where when the candidate prefetch method for the array “table[idx[i]]” is the first prefetch method (all-index prefetch), the degeneration determination unit 55 degenerates the first prefetch method (all-index prefetch) to the third prefetch method (better-prologue prefetch).

Then, the insertion unit 56 determines whether there is an array subject to prefetch (step S16). For example, the insertion unit 56 determines that there is no array subject to prefetch when the field of the prefetch method in the determination table TB3 is empty, and determines that there is an array subject to prefetch when the field of the prefetch method in the determination table TB3 is not empty.

When it is determined that there is no array subject to prefetch (step S16: NO), the process starts over from step S12 for the subsequent two consecutive loop processes.

When it is determined that there is an array subject to pre fetch (step S16: YES), the process proceeds to step S17.

In step S17, the insertion unit 56 writes the prefetch instruction corresponding to the prefetch method in the determination table TB3 to the preceding loop process. Additionally, the insertion unit 56 stores, as the intermediate code 23, the source program 21 to which the prefetch instruction has been inserted in the storage unit 41.

Then, the generation unit 57 generates the executable program 22 from the intermediate code 23, and stores the generated executable program 22 in the storage unit 41 (step S18).

In the above manner, the basic steps of the compiling method in accordance with the embodiment am completed.

Next, the determination process of the candidate prefetch method in step S14 will be described.

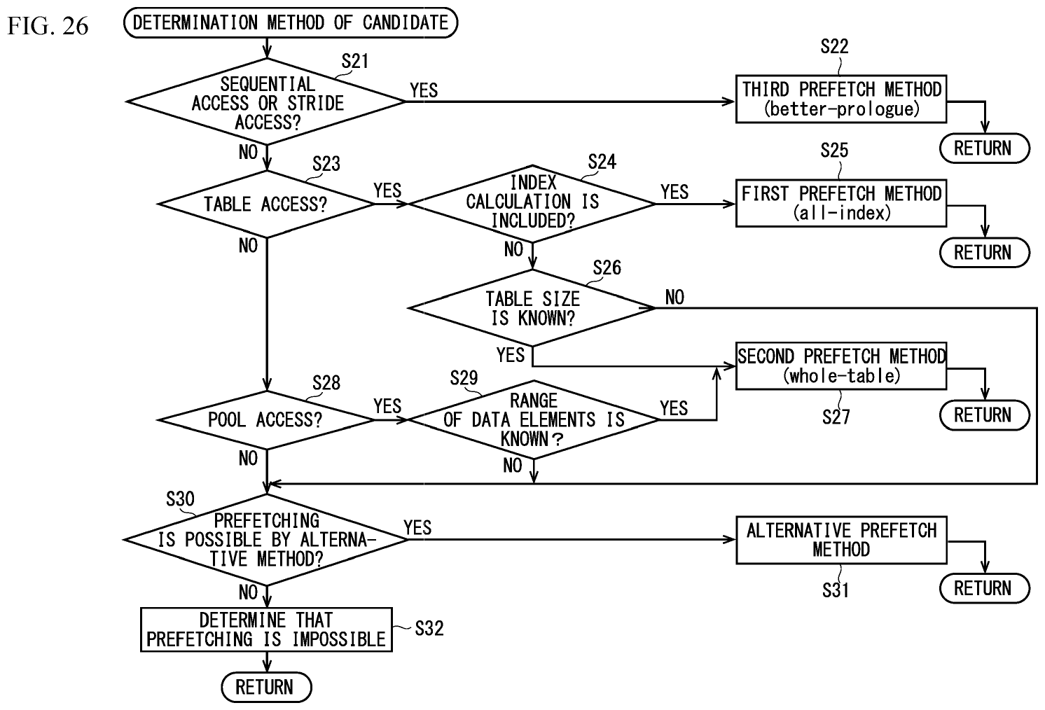

FIG. 26 is a flowchart of the determination process of the candidate prefetch method.

This flowchart is a flowchart for determining the candidate prefetch method by analyzing which of the cases 1 to 3 (FIG. 17 to FIG. 21) the process contents of the preceding loop process and the subsequent loop process correspond. This process of the flowchart is executed by the detection unit 53 for each array included in the subsequent loop process.

First, the detection unit 53 determines whether the access pattern in the subsequent loop process is the sequential access or the stride access (step S21). When it is determined that the access pattern in the subsequent loop process is the sequential access or the stride access (step S21: YES), the process proceeds to step S22, and the detection unit 53 selects the third prefetch method (better-prologue prefetch). Thereafter, the process returns to the caller.

When it is determined that the access pattern in the subsequent loop process is not the sequential access or the stride access (step S21: NO), the process proceeds to step S23. In step S23, the detection unit 53 determines whether the access pattern in the subsequent loop process is the table access.

When it is determined that the access pattern in the subsequent loop process is the table access (step S23: YES), the process proceeds to step S24. In step S24, the detection unit 53 determines whether the preceding loop process includes a process in which the index of the table is calculated.

When it is determined that the preceding loop process includes the process in which the index of the table is calculated (step S24: YES), the process proceeds to step S25, and the detection unit 53 selects the first prefetch method (all-index prefetch). Thereafter, the process returns to the caller.

When it is determined that the preceding loop process does not include the process in which the index of the table is calculated (step S24: NO), the process proceeds to step S26. In step S26, the detection unit 53 determines whether the table size is known. For example, when there is a statement that declares the table size is included in the source program 21, the detection unit 53 determines that the table size is known. When the statement that declares the table size is not included in the source program 21, the detection unit 53 determines that the table size is unknown.

When it is determined that the table size is known (step S26: YES), the process proceeds to step S27, and the detection unit 53 selects the second prefetch method (whole-table prefetch). Thereafter, the process returns to the caller.

When it is determined that the access pattern in the subsequent loop process is not the table access in step S23, the process proceeds to step S28.

In step S28, the detection unit 53 determines whether the access pattern in the subsequent loop process is the pool access. When it is determined that the access pattern in the subsequent loop process is the pool access (step S28: YES), the process proceeds to step S29.

In step S29, the detection unit 53 determines whether the range of the data elements pointed to by pointers in the pool area is known. For example, when a statement that declares the range is included in the source program 21, the detection unit 53 determines that the range of the data elements is known. When the statement that declares the range is not included in the source program 21, the detection unit 53 determines that the range of the data elements is unknown.

When it is determined that the range of the data elements pointed to by pointers in the pool area is known (step S29: YES), the process proceeds to step S27 described above, and the detection unit 53 selects the second prefetch method (whole-table prefetch).

When it is determined that the access pattern in the subsequent loop process is not the pool access in step S28, the process proceeds to step S30. When it is determined that the range of the data elements pointed to by pointers in the pool area is unknown in step S29, the process also proceeds to step S30. When it is determined that the table size is unknown in step S26, the process also proceeds to step S30.

In step S30, it is determined whether prefetching is possible by an alternative prefetch method different from all of the first to third prefetch methods. Examples of the alternative prefetch method include, but are not limited to, the prefetch method using the random number described in FIG. 23.

When it is determined that prefetching is possible by the alternative prefetch method (step S30: YES), the process proceeds to step S31, the detection unit 53 selects the alternative prefetch method, and the process returns to the caller.

When it is determined that prefetching is impossible by the alternative prefetch method (step S30: NO), the process proceeds to step S32.

In step S32, the detection unit 53 determines that it is impossible to prefetch the array, and the process returns to the caller.

In the above manner, the basic steps of the determination process of the candidate prefetch method are completed.

Even when the candidate prefetch method is determined as described above, if the cache memory 6 is not enough, it is impossible to execute prefetching. In such a case, the information processing device 20 performs the selection of the prefetch method and degeneration of the prefetch method in the degeneration determination process of step S15 in FIG. 25.

The prefetch method is selected taking into consideration the respective advantages of the first to third prefetch methods.

For example, the third prefetch method (better-prologue prefetch) has an advantage that the cache usage of the subsequent loop process does not increase. The first prefetch method (all-index prefetch) and the second prefetch method (whole-table prefetch) do not have this advantage. Taking this advantage into consideration, in the following example, the third prefetch method of the first to third prefetch methods is to be always executed.

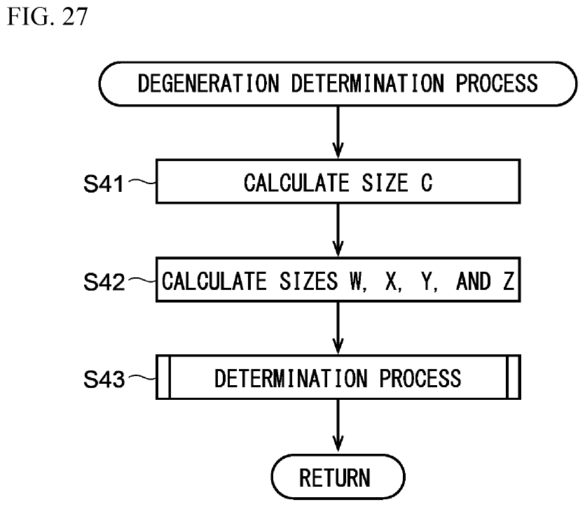

FIG. 27 is a flowchart of the degeneration determination process.

First, the calculation unit 54 calculates the size C of an area available in the cache memory 6 (step S41). Here, the calculation unit 54 calculates the size C using the equation C=the entire size of the cache memory 6−α. The calculation unit 54 calculates a as follows. The size C is an example of a first size.

First, the calculation unit 54 calculates the sum of the values of the following (a) to (c) with respect to each of the preceding loop process and the subsequent loop process.

(a) The total size (Byte) of the elements when each element of the array for which the third prefetch method (better-prologue prefetch) is selected as a candidate is prefetched by the third prefetch method.

(b) The total size (Byte) of the elements when each of the arrays for which the alternative prefetch method different from all of the first to third prefetch methods is selected as a candidate is prefetched by the alternative prefetch method.

(c) The number of arrays that are not subject to prefetch×the size of the cache line 9×β. Note that β is a constant determined by the architecture of the processor 2.

The calculation unit 54 employs the larger value between the sum of (a) to (c) of the preceding loop process and the sum of (a) to (c) of the subsequent loop process as α.

Here, α has a meaning as the size of the area that must be reserved in the cache memory 6. The total size of the array elements prefetched by the third prefetch method (better-prologue prefetch), which is (a), is included in α. Thus, the third prefetch method is always executed without being replaced by any other prefetch methods.

Then, the calculation unit 54 calculates the sizes W, X, Y, and Z (step S42). The meanings of these sizes are as follows.

W: The total size of the data elements to be transferred to the cache memory 6 by the prefetch instruction of the first prefetch method (all-index prefetch) in the preceding loop process. The prefetch instruction is, for example, the prefetch instruction “sector_prefetch(table[idx[i]])” of FIG. 10B. The size W is an example of a first total size. The data elements to be transferred to the cache memory 6 by the prefetch instruction of the first prefetch method (all-index prefetch) are examples of fourth data elements.

X: The total size of the data elements to be transferred to the cache memory 6 in the preceding loop process when the first prefetch method (all-index prefetch) is degenerated to the third prefetch method (better-prologue prefetch) as illustrated in FIG. 22 and the data elements to be transferred to the cache memory in the subsequent loop process when the first prefetch method (all-index prefetch) is degenerated to the third prefetch method (better-prologue prefetch). The size X is an example of a fourth total size. The data elements to be transferred to the cache memory 6 in the preceding loop process when the first prefetch method (all-index prefetch) is degenerated to the third prefetch method (better-prologue prefetch) are examples of seventh data elements, and the data elements to be transferred to the cache memory 6 in the subsequent loop process when the first prefetch method (all-index prefetch) is degenerated to the third prefetch method (better-prologue prefetch) are examples of eighth data elements.

Y: The total size of the data elements to be transferred to the cache memory 6 by the prefetch instruction of the second prefetch method (whole-table prefetch) in the preceding loop process. The prefetch instruction is, for example, the prefetch instruction “sector_prefetch(table[j])” of FIG. 12B. The size Y is an example of a second total size.

Z: The total size of the data elements to be transferred to the cache memory 6 in the preceding loop process when the second prefetch method (whole-table prefetch) is degenerated to the alternative prefetch method as illustrated in FIG. 23 and the data elements to be transferred to the cache memory 6 in the subsequent loop process when the second prefetch method (whole-table prefetch) is degenerated to the alternative prefetch method. The size Z is an example of a third total size. The data elements to be transferred to the cache memory 6 in the preceding loop process when the second prefetch method (whole-table prefetch) is degenerated to the alternative prefetch method are examples of fifth data elements, and the data elements to be transferred to the cache memory 6 in the subsequent loop process when the second prefetch method (whole-table prefetch) is degenerated to the alternative prefetch method are examples of sixth data elements.

Then, the degeneration determination unit 55 executes a determination process in which whether degeneration is to be performed is determined (step S43).

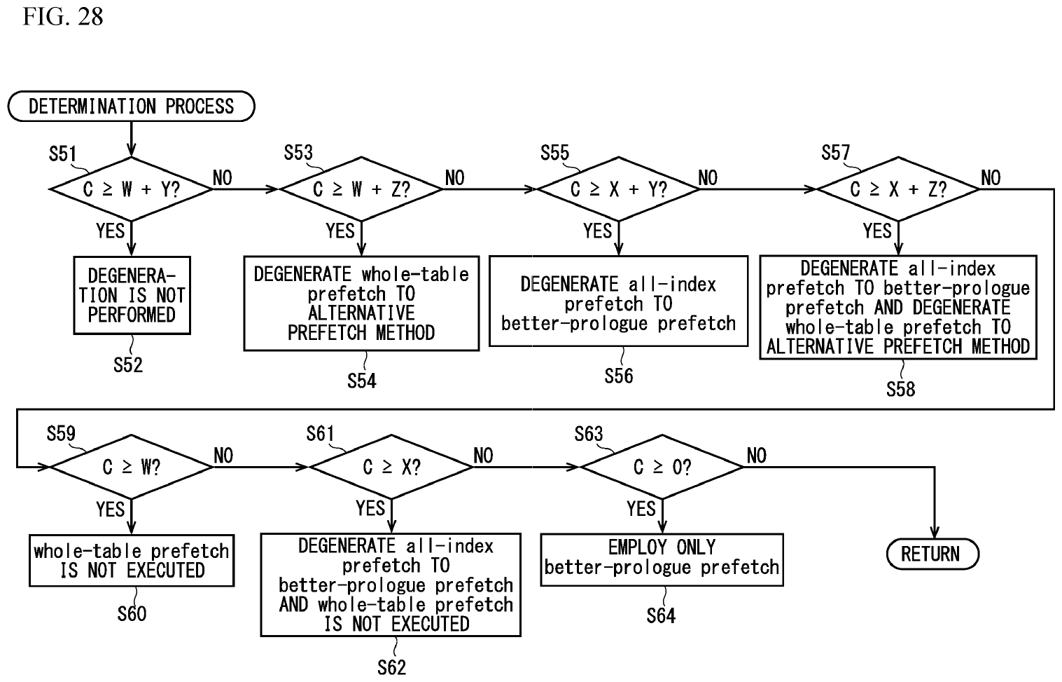

FIG. 28 is a flowchart of the determination process.

Hereinafter, assumed is case where three arrays are included in the subsequent loop process, and the first to third prefetch methods are determined as the candidate prefetch methods for the respective arrays.

First, the degeneration determination unit 55 determines whether “C≥W+Y” is established (step S51). When it is determined that “C≥W+Y” is established, the process proceeds to step S52.

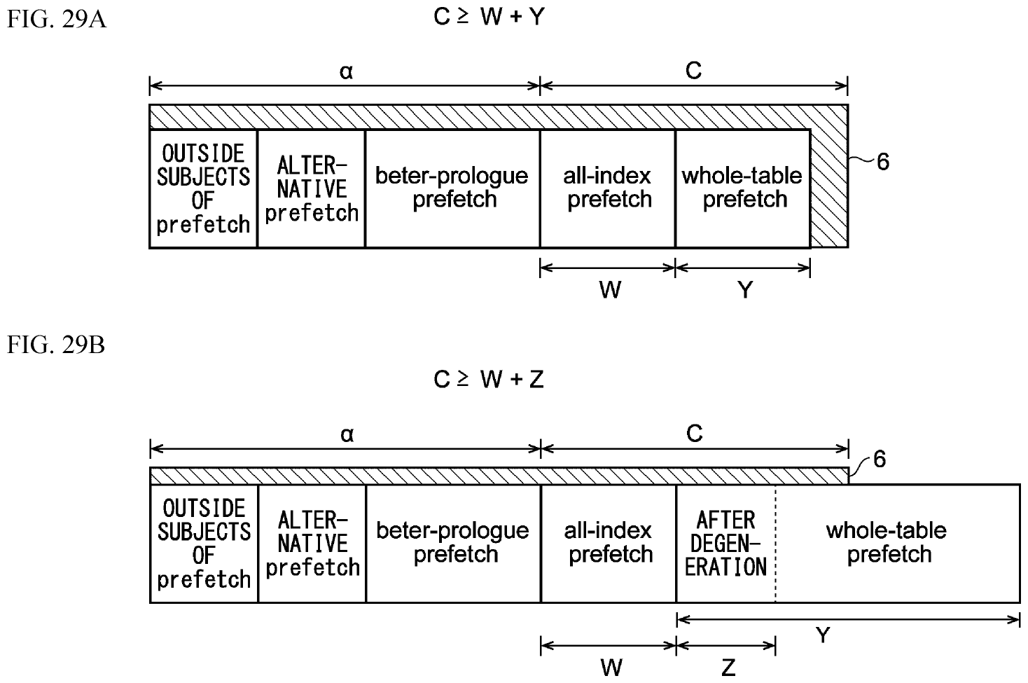

FIG. 29A is a schematic view of the cache memory 6 when “C≥W+Y” is established. As illustrated in FIG. 29A, in this case, even when degeneration is not performed, the total size (W+Y) of the data elements to be prefetched is less than the size C. Thus, in this case, in step S52, the degeneration determination unit 55 determines that degeneration is not performed.

Referring back to FIG. 28, the description will be continued.

When “C≥W+Y” is not established, the process proceeds to step S53. In step S53, the degeneration determination unit 55 determines whether “C≥W+Z” is established. When it is determined that “C≥W+Z” is established, the process proceeds to step S54.

FIG. 29B is a schematic view of the cache memory 6 when “C≥W+Z” is established. As illustrated in FIG. 29B, in this case, by degenerating the second prefetch method (whole-table prefetch) to the alternative prefetch method according to the method illustrated in FIG. 23, the total size (W+Z) of the data elements to be prefetched becomes smaller than the size C. Thus, in this case, in step S54, the degeneration determination unit 55 determines that the second prefetch method (whole-table prefetch) is degenerated to the alternative prefetch method. Then, the insertion unit 56 degenerates the second prefetch method (whole-table prefetch) to the alternative prefetch method in step S17 of FIG. 25.

Referring back to FIG. 28, the description will be continued.

When it is determined that “C≥W+Z” is not established (step S53: NO), the process proceeds to step S5. In step S55, the degeneration determination unit 55 determines whether “C≥X+Y” is established. When it is determined that “C≥X+Y” is established, the process proceeds to step S56.

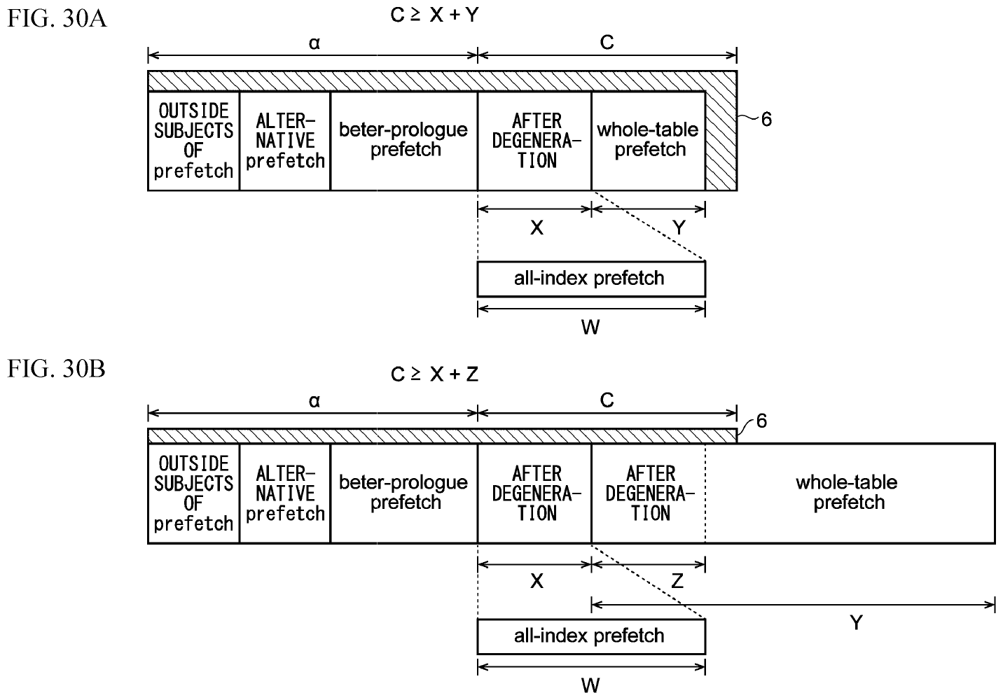

FIG. 30A is a schematic view of the cache memory 6 when “C≥X+Y” is established. As illustrated in FIG. 30A, in this case, by degenerating the first prefetch method (all-index prefetch) to the third prefetch method (better-prologue prefetch) according to the method illustrated in FIG. 22, the total size (X+Y) of the data elements to be prefetched becomes less than the size C. Thus, in this case, in step S56, the degeneration determination unit 55 determines that the first prefetch method (all-index prefetch) is degenerated to the third prefetch method (better-prologue prefetch). Men, the insertion unit 56 degenerates the first prefetch method (all-index prefetch) to the third prefetch method (better-prologue prefetch) in step S17 of FIG. 25.

Referring back to FIG. 28, the description will be continued.

When it is determined that “C≥X+Y” is not established (step S55: NO), the process proceeds to step S57. In step S57, the degeneration determination unit 55 determines whether “C≥X+Z” is established. When it is determined that “C≥X+Z” is established, the process proceeds to step S58.

FIG. 30B is a schematic view of the cache memory 6 when “C≥X+Z” is established. As illustrated in FIG. 30B, in this case, the total size (X+Z) of the data elements to be prefetched becomes smaller than the size C by degenerating the first prefetch method to the third prefetch method and degenerating the second prefetch method to the alternative prefetch method. Thus, in this case, in step S58, the degeneration determination unit 55 determines that the first prefetch method is degenerated to the third prefetch method and the second prefetch method is degenerated to the alternative prefetch method. Then, the insertion unit 56 performs these degeneration in step S17 of FIG. 25.

Referring back to FIG. 28, the description will be continued.

When it is determined that “C≥X+Z” is not established (step S57: NO), the process proceeds to step S59. In step S59, the degeneration determination unit 55 determines whether “C≥W” is established. When it is determined that “C≥W” is established, the process proceeds to step S60.

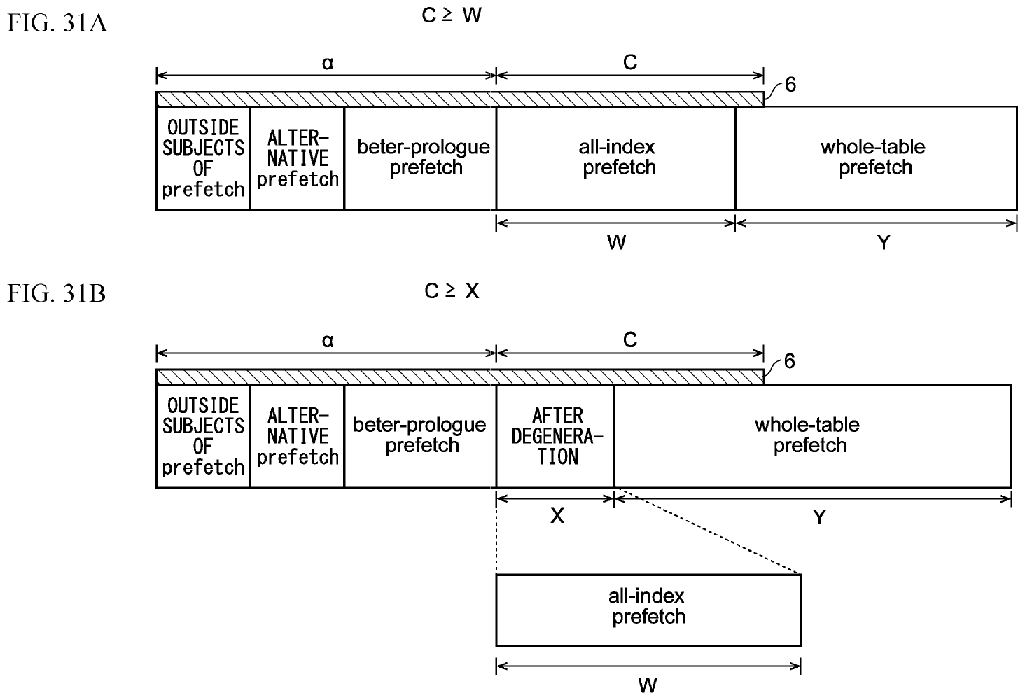

FIG. 31A is a schematic view of the cache memory 6 when “C≥W” is established. As illustrated in FIG. 31A, in this case, the total size (W) of the data elements to be prefetched becomes smaller than the size C when the second prefetch method (whole-table prefetch) is not executed.

Thus, in this case, in step S60, the degeneration determination unit 55 determines that the second prefetch method (whole-table prefetch) is not executed. Then, the insertion unit 56 does not insert the prefetch instruction to execute the second prefetch method (whole-table prefetch) to the preceding loop process in step S17 of FIG. 25. Examples of such a prefetch instruction include, but are not limited to, the prefetch instruction “sector_prefetch(table[j])” in FIG. 12B.

Referring back to FIG. 28, the description will be continued.

When it is determined that “C≥W” is not established (step S59: NO), the process proceeds to step S61. In step S61, the degeneration determination unit 55 determines whether “C≥X” is established. When it is determined that “C≥X” is established, the process proceeds to step S62.

FIG. 31B is a schematic view of the cache memory 6 when “C≥X” is established. In this case the total size (X) of the data elements to be prefetched becomes smaller than the size C when the first prefetch method (all-index prefetch) is degenerated to the third prefetch method and the second prefetch method (whole-table prefetch) is not executed.

Thus, in this case, in step S62, the degeneration determination unit 55 determines that the first prefetch method (all-index prefetch) is degenerated to the third prefetch method (better-prologue prefetch) and the second prefetch method (whole-table prefetch) is not executed. Then, the insertion unit 56 degenerates the first prefetch method (all-index prefetch) to the third prefetch method (better-prologue prefetch) in step S17 of FIG. 23. Along with this, the insertion unit 56 does not insert the prefetch instruction to execute the second prefetch method (whole-table prefetch) to the preceding loop process.

Referring back to FIG. 28, the description will be continued.

When it is determined that “C≥X” is established (step S61: NO), the process proceeds to step S63. In step S61, the degeneration determination unit 55 determines whether “C≥0” is established. When it is determined that “C≥0” is established, the process proceeds to step S64.

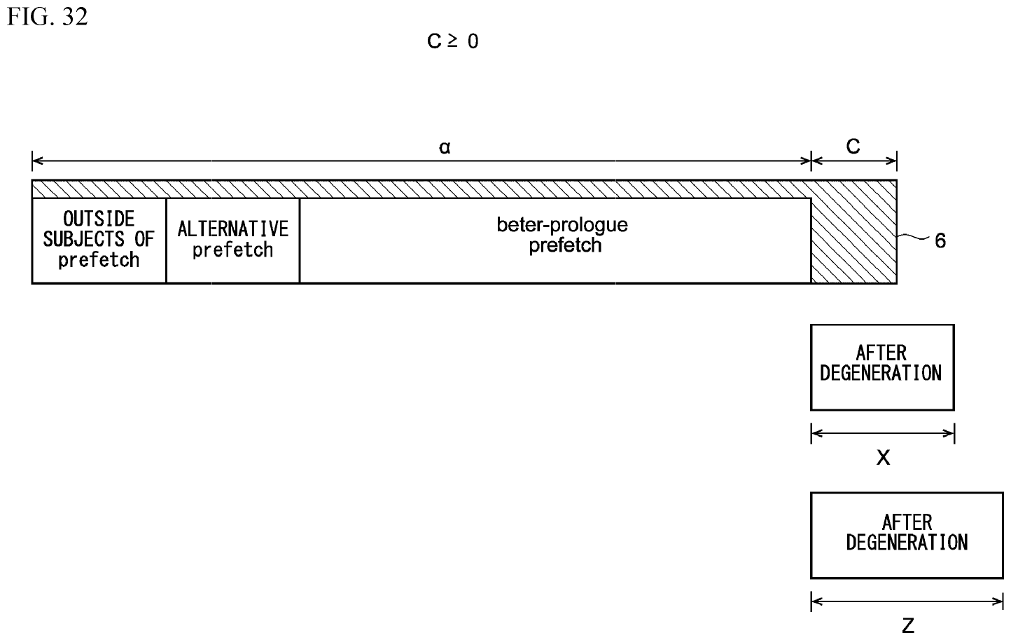

FIG. 32 is a schematic view of the cache memory 6 when “C≥0” is established. In this case, even when the first prefetch method is degenerated to the third prefetch method and the second prefetch method is degenerated to the alternative prefetch method, each of the total sizes X and Z after degeneration becomes larger than the size C.

Thus, in this case, in step S64, the degeneration determination unit 55 determines that only the third prefetch method (better-prologue prefetch) is employed among the first to third prefetch methods. Then, the insertion unit 56 inserts the prefetch instruction to execute the third prefetch method to the preceding loop process in step S17 of FIG. 25. Examples of such a prefetch instruction include, but are not limited to, the prefetch instruction “sector_prefetch(x[j])” in FIG. 14B.

Referring back to FIG. 28, the description will be continued.

When it is determined that “C≥0” is not established (step S63: NO), some of the prefetched data elements cannot be stored in the cache memory 6 no matter which of the first to third prefetch methods is employed. Thus, in this case, the process is ended without executing prefetching.

In the above manner, the basic steps of the determination process are completed.

This determination process allows to determine which of the first to third prefetch methods is employed taking into consideration the size C of the area available in the cache memory 6.

### Hardware Configuration

Next, a description will be given of the hardware configuration of the information processing device 20 in accordance with the embodiment.

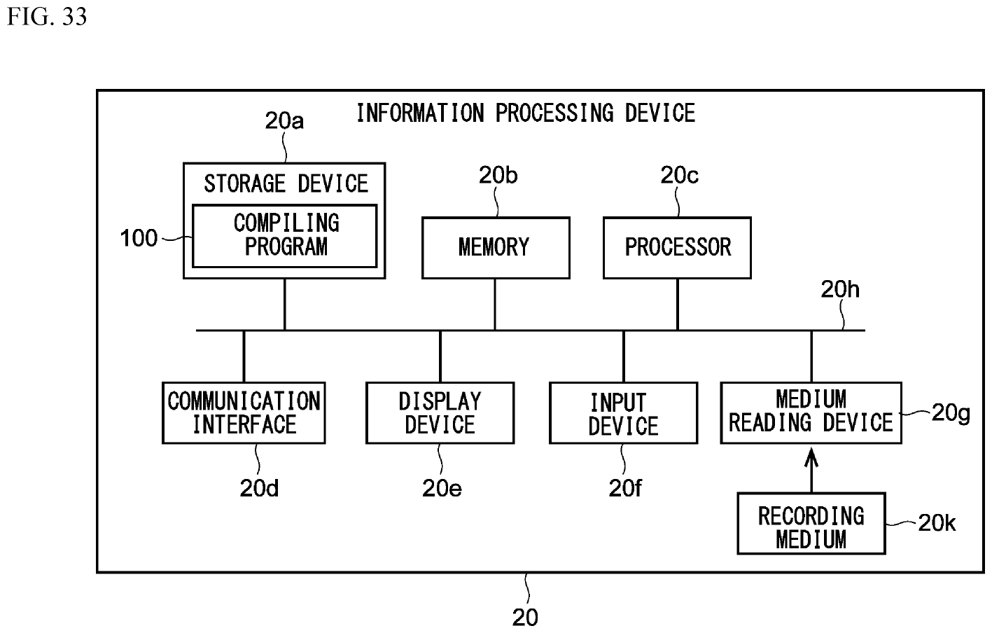

FIG. 33 is a hardware configuration diagram of the information processing device 20. As illustrated in FIG. 33, the information processing device 20 includes a storage device 20a, a memory 20b, a processor 20c, a communication interface 20d, a display device 20e, an input device 20f, and a medium reading device 20g. These components am connected to each other through a bus 20h.

The storage device 20a is a non-volatile storage such as a hard disk drive (HDD) and a solid state drive (SSD), and stores a compiling program 100 in accordance with the embodiment.

The compiling program 100 may be recorded in a computer-readable recording medium 20k, and the processor 20c may be caused to read the compiling program 100 through the medium reading device 20g.

Such a recording medium 20k may be a physically portable recording medium such as a CD-ROM, a DVD, or a USB memory, for example. Also, a semiconductor memory such as a flash memory, or a hard disk drive may be used as the recording medium 20k. Such a recording medium 20k is not a temporary medium such as carrier waves not having a physical form.

Further, the compiling program 100 may be stored in a device connected to a public line, the Internet, a LAN, or the like. In this case, the processor 20c reads and executes the compiling program 100.

Meanwhile, the memory 20b is hardware that temporarily stores data like a dynamic random access memory (DRAM) or the like. The compiling program 100 is loaded into the memory 20b.

The processor 20c is hardware such as a CPU or a GPU that controls the respective components of the information processing device 20. The processor 20c and the memory 20b cooperatively execute the compiling program 100.

As the memory 20b and the processor 20c cooperate to execute the compiling program 100, the control unit 42 of the information processing device 20 (see FIG. 24) is implemented. The control unit 42 includes the input unit 51, the determination unit 52, the detection unit 53, the calculation unit 54, the degeneration determination unit 55, the insertion unit 56, and the generation unit 57.

The storage unit 41 (see FIG. 24) is implemented by the storage device 20a and the memory 20b.

Further, the communication interface 20d is hardware such as a network interface card (NIC) for connecting the information processing device 20 to a network such as a LAN and the Internet.

The display device 20e is hardware such as a liquid crystal display or a touch panel for displaying various types of information.

The input device 20f is hardware such as a keyboard and a mouse for the developer to input the various types of data to the information processing device 20.

The medium reading device 20g is hardware such as a CD drive, a DVD drive, and a USB interface for reading the recording medium 20k.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An information processing device comprising:
a memory; and
a processor coupled to the memory and configured to:
detect an access pattern according to which a memory reference instruction in a first loop process to be executed posterior to a second loop process accesses first data elements in the memory every loop iteration, and
insert a prefetch instruction to the second loop process based on the access pattern, the prefetch instruction being an instruction to transfer at least one of the first data elements from the memory to a first sector of a cache memory, the at least one of the first data elements transferred to the first sector of the cache memory being never cached out by a second data element different from each of the first data elements.

2. The information processing device according to claim 1, wherein the prefetch instruction is one of the following instructions:
a first instruction to transfer, from the memory to the cache memory, third data elements corresponding to indexes calculated in the first loop process among the first data elements that are elements of a table,
a second instruction to transfer, from the memory to the cache memory, all the first data elements that are the elements of the table, and
a third instruction to transfer, from the memory to the cache memory, each of the first data elements aligned contiguous to each other in the memory or each of the first data elements aligned at a regular interval in the memory.

3. The information processing device according to claim 2,
wherein the access pattern is a table access in which the first data elements that are the elements of the table stored in the memory are accessed,
wherein the second loop process is a process in which the index of the table is calculated, and
wherein the processor is configured to insert the first instruction to the second loop process.

4. The information processing device according to claim 2,
wherein the access pattern is a table access in which the first data elements that are the elements of the table stored in the memory are accessed, or a pool access in which a data element pointed to by a pointer in a pool area reserved in the memory is accessed, and
wherein the processor is configured to insert the second instruction to the second loop process.

5. The information processing device according to claim 2,
wherein the access pattern is a sequential access in which the first data elements contiguous to each other in the memory are sequentially accessed every loop iteration in the first loop process, or a stride access in which the first data elements aligned at a regular interval in the memory are sequentially accessed every loop iteration in the first loop process, and
wherein the processor is configured to insert the third instruction to the second loop process.

6. The information processing device according to claim 2, wherein the processor is further configured to:
calculate a first size of an area available in the cache memory;
calculate a first total size of fourth data elements to be transferred to the cache memory by the first instruction among the first data elements in the second loop process,
calculate a second total size of the first data elements to be transferred to the cache memory by the second instruction in the second loop process,
calculate a third total size of fifth data elements and sixth data elements, the fifth data elements being data elements to be transferred to the cache memory among the first data elements in the second loop process when a first manipulation is performed, the sixth data elements being data elements to be transferred to the cache memory among the first data elements in the first loop process when the first manipulation is performed, the first manipulation being a manipulation that deletes the second instruction from the second loop process and inserts a fifth instruction to the first loop process, the fifth instruction being an instruction to transfer, from the memory to the cache memory, the first data element that is the element of the table, and
perform the first manipulation when a sum of the first total size and the second total size is greater than the first size, and a sum of the first total size and the third total size is equal to or less than the first size.

7. The information processing device according to claim 2, wherein the processor is further configured to:
calculate a first size of an area available in the cache memory,
calculate a first total size of fourth data elements to be transferred to the cache memory by the first instruction among the first data elements in the second loop process;
calculate a second total size of the first data elements to be transferred to the cache memory by the second instruction in the second loop process,
calculate a fourth total size of seventh data elements and eighth data elements, the seventh data elements being data elements to be transferred to the cache memory among the first data elements in the second loop process when a second manipulation is performed, the eighth data elements being data elements to be transferred to the cache memory among the first data elements in the first loop process when the second manipulation is performed, the second manipulation being a manipulation that reduces a number of the first instructions executed in the second loop process and inserts a fourth instruction to the first loop process, the fourth instruction being an instruction to transfer, from the memory to the cache memory, the element corresponding to an index greater than all of the indexes calculated, and
perform the second manipulation when a sum of the first total size and the second total size is greater than the first size, and a sum of the second total size and the fourth total size is equal to or less than the first size.

8. The information processing device according to claim 2, wherein the processor is further configured to:
calculate a first size of an area available in the cache memory;
calculate a first total size of fourth data elements to be transferred to the cache memory by the first instruction among the first data elements in the second loop process,
calculate a second total size of the first data elements to be transferred to the cache memory by the second instruction in the second loop process,
calculate a third total size of fifth data elements and sixth data elements, the fifth data elements being data elements to be transferred to the cache memory among the first data elements in the second loop process when a first manipulation is performed, the sixth data elements being data elements to be transferred to the cache memory among the first data elements in the first loop process when the first manipulation is performed, the first manipulation being a manipulation that deletes the second instruction from the second loop process and inserts a fifth instruction to the first loop process, the fifth instruction being an instruction to transfer, from the memory to the cache memory, the first data element that is the element of the table,
calculate a fourth total size of seventh data elements and eighth data elements, the seventh data elements being data elements to be transferred to the cache memory among the first data elements in the second loop process, the eighth data elements being data elements to be transferred to the cache memory among the first data elements in the first loop process when the second manipulation is performed, the second manipulation being a manipulation that reduces a number of the first instructions executed in the second loop process and inserts a fourth instruction to the first loop process, the fourth instruction being an instruction to transfer, from the memory to the cache memory, the element corresponding to an index greater than all of the indexes calculated, and
perform the first manipulation and the second manipulation when a sum of the first total size and the second total size is greater than the first size, and a sum of the third total size and the fourth total size is equal to or less than the first size.

9. The information processing device according to claim 2, wherein the processor is further configured to:
calculate a first size of an area available in the cache memory,
calculate a first total size of fourth data elements to be transferred to the cache memory by the first instruction among the first data elements in the second loop process,
calculate a second total size of the first data elements to be transferred to the cache memory by the second instruction in the second loop process, and
insert the first instruction to the first loop process without inserting the second instruction when a sum of the first total size and the second total size is greater than the first size and the first total size is equal to or less than the first size.

10. The information processing device according to claim 2, wherein the processor is further configured to:
calculate a first size of an area available in the cache memory,
calculate a first total size of fourth data elements to be transferred to the cache memory by the first instruction among the first data elements in the second loop process,
calculate a second total size of the first data elements to be transferred to the cache memory by the second instruction in the second loop process,
calculate a fourth total size of seventh data elements and eighth data elements, the seventh data elements being data elements to be transferred to the cache memory among the first data elements in the second loop process when a second manipulation is performed, the eighth data elements being data elements to be transferred to the cache memory among the first data elements in the first loop process when the second manipulation is performed, the second manipulation being a manipulation that reduces a number of the first instructions executed in the second loop process and inserts a fourth instruction to the first loop process, the fourth instruction being an instruction to transfer, from the memory to the cache memory, the element corresponding to an index greater than all of the indexes calculated, and
perform the second manipulation and not to insert the second instruction to the second loop process when a sum of the first total size and the second total size is greater than first size and the fourth total size is equal to or less than the first size.

11. The information processing device according to claim 2, wherein the processor is further configured to:
calculate a first size of an area available in the cache memory,
calculate a first total size of fourth data elements to be transferred to the cache memory by the first instruction among the first data elements in the second loop process,
calculate a second total size of the first data elements to be transferred to the cache memory by the second instruction in the second loop process,
calculate a third total size of fifth data elements and sixth data elements, the fifth data elements being data elements to be transferred to the cache memory among the first data elements in the second loop process when a first manipulation is performed, the sixth data elements being data elements to be transferred to the cache memory among the first data elements in the first loop process when the first manipulation is performed, the first manipulation being a manipulation that deletes the second instruction from the second loop process and inserts a fifth instruction to the first loop process, the fifth instruction being an instruction to transfer, from the memory to the cache memory, the first data element that is the element of the table,
calculate a fourth total size of seventh data elements and eighth data elements, the seventh data elements being data elements to be transferred to the cache memory among the first data elements in the second loop process when a second manipulation is performed, the eighth data elements being data elements to be transferred to the cache memory among the first data elements in the first loop process when the second manipulation is performed, the second manipulation being a manipulation that reduces a number of the first instructions executed in the second loop process and inserts a fourth instruction to the first loop process, the fourth instruction being an instruction to transfer, from the memory to the cache memory, the element corresponding to an index greater than all of the indexes calculated, and
insert neither the first instruction nor the second instruction to the first loop process when a sum of the first total size and the second total size is greater than the first size and the third total size and the fourth total size are both greater than the first size.

12. The information processing device according to claim 1, wherein a total number of clock cycles required for an operation process executed by an arithmetic unit is greater than a total number of clock cycles required for the arithmetic unit to reference the first data element in the memory in the second loop process.

13. The information processing device according to claim 1, wherein the cache memory includes a second sector that stores the second data element transferred from the memory.

14. A compiling method implemented by a computer, the compiling method comprising:
detecting an access pattern according to which a memory reference instruction in a first loop process to be executed posterior to a second loop process accesses first data elements in the memory every loop iteration; and
inserting a prefetch instruction to the second loop process based on the access pattern, the prefetch instruction being an instruction to transfer at least one of the first data elements from the memory to a first sector of a cache memory, the at least one of the first data elements transferred to the first sector of the cache memory being never cached out by a second data element different from each of the first data elements.

15. A non-transitory computer-readable recording medium storing a program that causes a computer to execute a process, the process comprising:
detecting an access pattern according to which a memory reference instruction in a first loop process to be executed posterior to a second loop process accesses first data elements in the memory every loop iteration; and
inserting a prefetch instruction to the second loop process based on the access pattern, the prefetch instruction being an instruction to transfer at least one of the first data elements from the memory to a first sector of a cache memory, the at least one of the first data elements transferred to the first sector of the cache memory being never cached out by a second data element different from each of the first data elements.
